(19) United States
(12) Patent Application Publication
(10) Pub. No.: US 2021/0383590 A1
(43) Pub. Date: Dec. 9, 2021

(54) Offset Texture Layers for Encoding and Signaling Reflection and Refraction for Immersive Video and Related Methods for Multi-Layer Volumetric Video

(71) Applicant: Nokia Technologies Oy, Espoo (FI)

(72) Inventors: Kimmo Tapio Roimela, Tampere (FI); Vinod Kumar Malamal Vadakital, Tampere (FI); Lauri Ilola, Tampere (FI); Lukasz Kondrad, Munich (DE); Jaakko Keranen, Helsinki (FI)

(21) Appl. No.: 17/330,647

(22) Filed: May 26, 2021

Related U.S. Application Data
(60) Provisional application No. 63/030,358, filed on May 27, 2020.

(51) Int. Cl. G06T 15/04; G06T 15/08; G06T 15/20; H04N 19/23

(52) U.S. Cl. CPC G06T 15/04; H04N 19/23; G06T 15/20; G06T 15/08

(57) ABSTRACT

An apparatus includes at least one processor; and at least one non-transitory memory including computer program code; wherein the at least one memory and the computer program code are configured to, with the at least one processor, cause the apparatus at least to: provide patch metadata to signal view-dependent transformations of a texture layer of volumetric data; provide the patch metadata to comprise at least one of: a depth offset of the texture layer with respect to a geometry surface, or texture transformation parameters; and wherein the patch metadata enables a renderer to offset texture coordinates of the texture layer based on a viewing position.

### RELATED APPLICATION

This application claims the benefit of U.S. Provisional Application No. 63/030,358, filed May 27, 2020, which is herein incorporated by reference in its entirety.

### TECHNICAL FIELD

The examples and non-limiting embodiments relate generally to volumetric video, and more particularly, to offset texture layers for encoding and signaling reflection and refraction for immersive video and related methods for multi-layer volumetric video.

### BACKGROUND

It is known to implement a codec to compress and decompress data such as video data.

### SUMMARY

In accordance with an aspect, an apparatus includes at least one processor; and at least one non-transitory memory including computer program code; wherein the at least one memory and the computer program code are configured to, with the at least one processor, cause the apparatus at least to: provide patch metadata to signal view-dependent transformations of a texture layer of volumetric data; provide the patch metadata to comprise at least one of: a depth offset of the texture layer with respect to a geometry surface, or texture transformation parameters; and wherein the patch metadata enables a renderer to offset texture coordinates of the texture layer based on a viewing position.

In accordance with an aspect, an apparatus includes at least one processor; and at least one non-transitory memory including computer program code; wherein the at least one memory and the computer program code are configured to, with the at least one processor, cause the apparatus at least to: add a volumetric media layer to immersive video coding; add an explicit volumetric media layer; add volumetric media attributes to a plurality of coded two-dimensional patches; and add volumetric media via a plurality of separate volumetric media view patches.

In accordance with an aspect, an apparatus includes at least one processor; and at least one non-transitory memory including computer program code; wherein the at least one memory and the computer program code are configured to, with the at least one processor, cause the apparatus at least to: divide a scene into a low-resolution base layer and a full-resolution detail layer; downsample the base layer to a resolution that is substantially lower than a target rendering resolution; and encode views of the detail layer at a full output resolution.

### BRIEF DESCRIPTION OF THE DRAWINGS

The foregoing aspects and other features are explained in the following description, taken in connection with the accompanying drawings, wherein:

FIG. 1 shows an example of view-based rendering from coded viewpoints.

FIG. 2A, FIG. 2B, and FIG. 2C (collectively FIG. 2) depict an example V3C bitstream structure.

FIG. 3A illustrates the problem of view-dependent texturing demonstrated on a translucent surface.

FIG. 3B illustrates the problem of rendering the location of a reflection.

FIG. 4 illustrates specular highlight lobes for two pixels A and B on a complex geometry patch.

FIG. 5 depicts an example rendering pipeline based on the examples described herein.

FIG. 6 depicts an example reflection texture offset from the geometric surface.

FIG. 7 shows an example of signaling a single depth offset in suitable scene depth units within a patch data unit structure.

FIG. 8 shows an example of signaling a single depth offset in suitable scene depth units as an SEI message.

FIG. 9 depicts an example reflection texture offset from the geometric surface.

FIG. 10 shows example signaling of specular metadata values within a patch data unit structure.

FIG. 11 is a table highlighting new component types for specular vector and color.

FIG. 12 is an example multi view encoding description, based on the examples described herein.

FIG. 13 illustrates an example of adding a specular contribution to a plurality of layers.

FIG. 14 shows example base and detail layers covering a volumetric video scene.

FIG. 15 is an example apparatus, which may be implemented in hardware, configured to implement the encoding and/or signaling of data based on the examples described herein.

FIG. 16 is an example method for implementing coding, decoding, and/or signaling based on the example embodiments described herein.

FIG. 17 is an example method for implementing coding, decoding, and/or signaling based on the example embodiments described herein.

FIG. 18 is an example method for implementing coding, decoding, and/or signaling based on the example embodiments described herein.

### DETAILED DESCRIPTION OF EXAMPLE EMBODIMENTS

Volumetric video data represents a three-dimensional scene or object and can be used as input for AR, VR and MR applications. Such data describes geometry (shape, size, position in 3D-space) and respective attributes (e.g. color, opacity, reflectance, etc.), plus any possible temporal changes of the geometry and attributes at given time instances (like frames in 2D video). Volumetric video is either generated from 3D models, i.e. CGI, or captured from real-world scenes using a variety of capture solutions, e.g. multi-camera, laser scan, combination of video and dedicated depth sensors, and more. Also, a combination of CGI and real-world data is possible. Typical representation formats for such volumetric data are triangle meshes, point clouds, or voxel(s). Temporal information about the scene can be included in the form of individual capture instances, i.e. “frames” in 2D video, or other means, e.g. position of an object as a function of time.

Because volumetric video describes a 3D scene (or object), such data can be viewed from any viewpoint. Therefore, volumetric video is an important format for any AR, VR, or MR applications, especially for providing 6DOF viewing capabilities.

Increasing computational resources and advances in 3D data acquisition devices has enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as set of texture and at least one depth map as is the case in the multi-view plus depth. Closely related to the techniques used in multi-view plus depth is the use of elevation maps, and multi-level surface maps.

Compression of volumetric video data is essential. In dense point clouds or voxel arrays, the reconstructed 3D scene may contain tens or even hundreds of millions of points. If such representations are to be stored or interchanged between entities, then efficient compression becomes essential. Standard volumetric video representation formats, such as point clouds, meshes, voxel, suffer from poor temporal compression performance. Identifying correspondences for motion-compensation in 3D-space is an ill-defined problem, as both geometry and respective attributes may change. For example, temporal successive “frames” do not necessarily have the same number of meshes, points or voxel(s). Therefore, compression of dynamic 3D scenes is inefficient. 2D-video based approaches for compressing volumetric data, i.e. multiview+depth, have much better compression efficiency, but rarely cover the full scene. Therefore, they provide limited 6DOF capabilities.

Instead of the above-mentioned approach, a 3D scene, represented as meshes, points, and/or voxel(s), can be projected onto one, or more, geometries. These geometries are “unfolded” onto 2D planes (two planes per geometry: one for texture, one for depth), which are then encoded using standard 2D video compression technologies. Relevant projection geometry information is transmitted alongside the encoded video files to the decoder. The decoder decodes the video and performs the inverse projection to regenerate the 3D scene in any desired representation format (not necessarily the starting format).

Projecting volumetric models onto 2D planes allows for using standard 2D video coding tools with highly efficient temporal compression. Thus, coding efficiency is increased greatly. Using geometry-projections instead of prior-art 2D-video based approaches, i.e. multiview+depth, provide a better coverage of the scene (or object). Thus, 6DOF capabilities are improved. Using several geometries for individual objects improves the coverage of the scene further. Furthermore, standard video encoding hardware can be utilized for real-time compression/decompression of the projected planes. The projection and reverse projection steps are of low complexity.

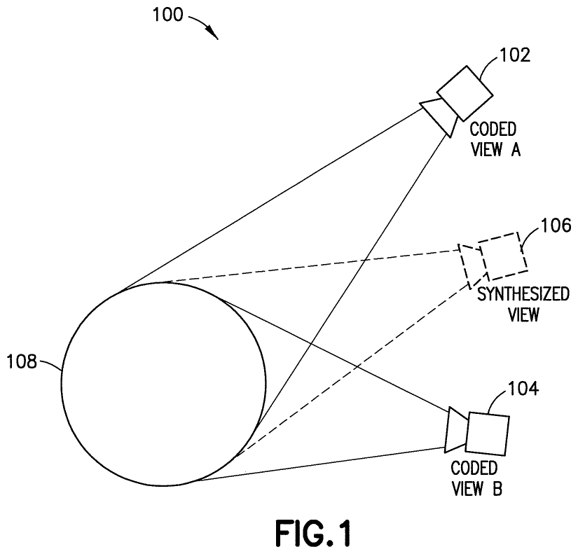

FIG. 1 shows an example 100 of view-based rendering from coded viewpoints. The rendering 108 of 3D immersive video projected into 2D video planes relies on the depth channel in the stored 2D video views. The geometry is reconstructed from the depth channels and the corresponding view parameters, and novel viewpoints are synthesized by blending the texture from the closest viewpoints. Thus, synthesized view of renderer 106 is generated by blending texture from coded view A of renderer 102 and coded view B of renderer 104. A renderer, as used throughout this description, is for example a camera, a projector, a display, etc.

In the highest level V3C metadata is carried in vpcc_units which consist of header and payload pairs. Below is the syntax for vpcc_units and vpcc_unit_header structures.

The general V-PCC unit syntax is:

| vpcc_unit( numBytesInVPCCUnit) { | Descriptor |
|---|---|
| vpcc_unit_header( ) | |
| vpcc_unit_payload( ) | |
| while( more_data_in_vpcc_unit ) | |
| trailing_zero_bits /* equal to 0x00 */ | f(8) |
| } | |

The V-PCC unit header syntax is:

| vpcc_unit_header( ) { | Descriptor |
|---|---|
| vuh_unit_type | u(5) |
| if( vuh_unit_type = = VPCC_AVD \| \| vuh_unit_ty | |
| pe = = VPCC_GVD \| \| | |
| vuh_unit_type = =VPCC_OVD \| \| vuh_unit_type = | |
| = VPCC_AD ) { | |
| vuh_vpcc_parameter_set_id | u(4) |
| vuh_atlas_id | u(6) |
| } | |
| if( vuh_unit_type = = VPCC_AVD ) { | |
| vuh_attribute_index | u(7) |
| vuh_attribute_dimension_index | u(5) |
| vuh_map_index | u(4) |
| vuh_auxiliary_video_flag | u(1) |
| } else if( vuh_unit_type = = VPCC_GVD ) { | |
| vuh_map_index | u(4) |
| vuh_auxiliary_video_flag | u(1) |
| vuh_reserved_zero_12bits | u(12) |
| } else | |
| if( vuh_unit_type = = VPCC_OVD \| \| vuh unit type | |
| = = VPCC_AD ) | |
| vuh_reserved_zero_17bits | u(17) |
| else | |
| vuh_reserved_zero_27bits | u(27) |
| } | |

The VPCC unit payload syntax is:

| vpcc_unit_payload( ) { | Descriptor |
|---|---|
| if( vuh_unit_type = = VPCC_VPS ) | |
| vpcc_parameter_set( ) | |
| else if( vuh_unit_type = = VPCC_AD ) | |
| atlas_sub_bitstream( ) | |
| else if( vuh_unit_type = = VPCC_OVD \| \| | |
| vuh_unit_type = = VPCC_GVD \| \| | |
| vuh_unit_type = = VPCC_AVD) | |
| video_sub_bitstream( ) | |
| } | |

V3C metadata is contained in atlas_sub_bistream( ) which may contain a sequence of NAL units including header and payload data. nal_unit_header( ) is used define how to process the payload data. NumBytesInNalUnit specifies the size of the NAL unit in bytes. This value is required for decoding of the NAL unit. Some form of demarcation of NAL unit boundaries is necessary to enable inference of NumBytesInNalUnit. One such demarcation method is specified in Annex C (23090-5) for the sample stream format.

A V3C atlas coding layer (ACL) is specified to efficiently represent the content of the patch data. The NAL is specified to format that data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex C (23090-5) each NAL unit can be preceded by an additional element that specifies the size of the NAL unit.

The General NAL unit syntax is:

| nal_unit( NumBytesInNalUnit ) { | Descriptor |
|---|---|
| nal_unit_header( ) | |
| NumBytesInRbsp = 0 | |
| for( i = 2; i < NumBytesInNalUnit; i++ ) | |
| rbsp_byte[ NumBytesInRbsp++ ] | b(8) |
| } | |

The NAL unit header syntax is:

| nal_unit_header( ) { | Descriptor |
|---|---|
| nal_forbidden_zero_bit | f(1) |
| nal_unit_type | u(6) |
| nal_layer_id | u(6) |
| nal_temporal_id_plus1 | u(3) |
| } | |

In the nal_unit_header( ) syntax nal_unit_type specifies the type of the RBSP data structure contained in the NAL unit as specified in Table 7.3 of 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of the current version of 23090-5 shall ignore (i.e., remove from the bitstream and discard) all NAL units with values of nal_layer_id not equal to 0.

rbsp_byte[i] is the i-th byte of an RBSP. An RBSP is specified as an ordered sequence of bytes. The RBSP contains a string of data bits (SODB). If the SODB is empty (i.e., zero bits in length), the RBSP is also empty.

Otherwise, the RBSP contains the SODB as follows: the first byte of the RBSP contains the first (most significant, left-most) eight bits of the SODB; the next byte of the RBSP contains the next eight bits of the SODS, etc., until fewer than eight bits of the SODB remain. The rbsp_trailing_bits( ) syntax structure is present after the SODS wherein i) the first (most significant, left-most) bits of the final RBSP byte contain the remaining bits of the SODS (if any); ii) the next bit consists of a single bit equal to 1 (i.e., rbsp_stop_one_bit); iii) when the rbsp_stop_one_bit is not the last bit of a byte-aligned byte, one or more bits equal to 0 (i.e. instances of rbsp_alignment_zero_bit) are present to result in byte alignment. One or more cabac_zero_word 16-bit syntax elements equal to 0x0000 may be present in some RBSPs after the rbsp_trailing_bits( ) at the end of the RBSP.

Syntax structures having these RBSP properties are denoted in the syntax tables using an “_rbsp” suffix. These structures are carried within NAL units as the content of the rbsp_byte[i] data bytes. Example typical content may include:
atlas_sequence_parameter_set_rbsp( ), which is used to carry parameters related to a sequence of V3C frames.
atlas_frame_parameter_set_rbsp( ), which is used to carry parameters related to a specific frame. Can be applied for a sequence of frames as well.
sei_rbsp( ), used to carry SEI messages in NAL units.
atlas_tile_group_layer_rbsp( ), used to carry patch layout information for tile groups.

When the boundaries of the RBSP are known, the decoder can extract the SODB from the RBSP by concatenating the bits of the bytes of the RBSP and discarding the rbsp stop one bit, which is the last (least significant, right-most) bit equal to 1, and discarding any following (less significant, farther to the right) bits that follow it, which are equal to 0. The data necessary for the decoding process is contained in the SODB part of the RBSP. The below tables describe relevant RBSP syntaxes.

The Atlas tile group layer RBSP syntax is

| | Descriptor |
|---|---|
| atlas_tile_group_layer_rbsp( ) { | |
| atlas_tile_group_header( ) | |
| if( atgh_type != SKIP_TILE_GRP ) | |
| atlas_tile_group_data_unit( ) | |
| rbsp_trailing_bits( ) | |
| } | |

The Atlas tile group header syntax is:

| | Descriptor |
|---|---|
| atlas_tile_group_header( ) { | |
| atgh_atlas_frame_parameter_set_id | ue(v) |
| atgh_address | u(v) |
| atgh_type | ue(v) |
| atgh_atlas_frm_order_cnt_lsb | u(v) |
| if( asps_num_ref_atlas_frame_lists_in_asps > 0 ) | |
| atgh_ref_atlas_frame_list_sps_flag | u(1) |
| if( atgh_ref_atlas_frame_list_sps_flag == 0 ) | |
| ref_list_struct( asps_num_ref_atlas_frame_lists_ | |
| in_asps ) | |
| else | |
| if( asps_num_ref_atlas_frame_lists_in_asps > 1 ) | |
| atgh_ref_atlas_frame_list_idx | u(v) |
| for( j = 0; j < NumLtrAtlasFrmEntries; j++){ | |
| atgh_additional_afoc_lsb_present_flag[ j ] | u(1) |
| if( atgh_additional_afoc_lsb_present_flag[ j ] ) | |
| atgh_additional_afoc_lsb_val[ j ] | u(v) |
| } | |
| if( atgh_type ! = SKIP_TILE_GRP ) { | |
| if( asps_normal_axis_limits_quantization_enabled | |
| _flag ) { | |
| atgh_pos_min_z_quantizer | u(5) |
| if( asps_normal_axis_max_delta_value_enabled_fla | |
| g ) | |
| atgh_pos_delta_max_z_quantizer | u(5) |
| } | |
| if( asps_patch_size_quantizer_present_flag ) { | |
| atgh_patch_size_x_info_quantizer | u(3) |
| atgh_patch_size_y_info_quantizer | u(3) |
| } | |
| if( afps_raw_3d_pos_bit_count_explicit_mode_flag | |
| ) | |
| atgh_raw_3d_pos_axis_bit_count_minus1 | u(v) |
| if( atgh_type = = P_TILE_GRP && num_ref_entri | |
| es[ RlsIdx ] > 1 ) { | |
| atgh_num_ref_idx_active_override_flag | u(1) |
| if( atgh_num_ref_idx_active_override_flag ) | |
| atgh_num_ref_idx_active_minus1 | ue(v) |
| } | |
| } | |
| byte_alignment( ) | |
| } | |

The general atlas tile group data unit syntax is:

| | Descriptor |
|---|---|
| atlas_tile_group_data_unit( ) { | |
| p = 0 | |
| atgdu_patch_mode[ p ] | ue(v) |
| while( atgdu_patch_mode[ p ] !=I_END && atgdu_pa | |
| tch_mode[ p ] != P_END) { | |
| patch_information_data( p, | |
| atgdu_patch_mode[ p ] ) | |
| p ++ | |
| atgdu_patch_mode[ p ] | ue(v) |
| } | |
| AtgduTotalNumberOfPatches = p | |
| byte_alignment( ) | |
| } | |

The patch information data syntax is:

| | Descriptor |
|---|---|
| patch_information_data ( patchIdx, patchMode ) { | |
| if ( atgh_type = = SKIP_TILE_GR ) | |
| skip_patch_data_unit( patchIdx ) | |
| else if ( atgh_type = = P_TILE_GR ) { | |
| if(patchMode = = P_SKIP ) | |
| skip_patch_data_unit( patchIdx ) | |
| else if(patchMode = = P_MERGE ) | |
| merge_patch_data_unit( patchIdx ) | |
| else if( patchMode = = P_INTRA ) | |
| patch_data_unit( patchIdx ) | |
| else if( patchMode = = P_INTER) | |
| inter_patch_data_unit( patchIdx ) | |
| else if( patchMode = = P_RAW ) | |
| raw_patch_data_unit( patchIdx ) | |
| else if( patchMode = = P_EOM ) | |
| eom_patch_data_unit( patchIdx ) | |
| } | |
| else if ( atgh_type = = I_TILE_GR ) { | |
| if( patchMode = = I_INTRA ) | |
| patch_data_unit( patchIdx ) | |
| else if( patchMode = = I_RAW ) | |
| raw_patch_data_unit( patchIdx ) | |
| else if( patchMode = = I_EOM ) | |
| eom_patch_data_unit( patchIdx ) | |
| } | |
| } | |

The patch data unit syntax is:

| | Descriptor |
|---|---|
| patch_data_unit( patchIdx ) { | |
| pdu_2d_pos_x[ patchIdx ] | u(v) |
| pdu_2d_pos_y[ patchIdx ] | u(v) |
| pdu_2d_delta_size_x[ patchIdx ] | se(v) |
| pdu_2d_delta_size_y[ patchIdx ] | se(v) |
| pdu_3d_pos_x[ patchIdx ] | u(v) |
| pdu_3d_pos_y[ patchIdx ] | u(v) |
| pdu_3d_pos_min_z[ patchIdx ] | u(v) |
| if( asps_normal_axis_max_delta_value_enable | |
| d_flag ) | |
| pdu_3d_pos_delta_max_z[ patchIdx ] | u(v) |
| pdu_projection_id[ patchIdx ] | u(v) |
| pdu_orientation index[ patchIdx ] | u(v) |
| if( afps_lod_mode_enabled_flag ) { | |
| pdu_lod enabled flag[ patchIndex ] | u(1) |
| if( pdu_lod_enabled_flag[ patchIndex ] > 0 | |
| ) { | |
| pdu_lod_scale_x_minus1[ patchIndex ] | ue(v) |
| pdu_lod_scale_y[ patchIndex ] | ue(v) |
| } | |
| } | u(v) |
| if( | |
| asps_point_local_reconstruction_enabled_flag ) | |
| point_local_reconstruction_data( patchIdx ) | |
| } | |

Annex F of V3C V-PCC specification (23090-5) describes different SEI messages that have been defined for V3C MIV purposes. SEI messages assist in processes related to decoding, reconstruction, display, or other purposes. Annex F (23090-5) defines two types of SEI messages: essential and non-essential. V3C SEI messages are signaled in sei_rspb( ) which is documented below.

| | Descriptor |
|---|---|
| sei_rbsp( ) { | |
| do | |
| sei_message( ) | |
| while( more_rbsp_data( ) ) | |
| rbsp_trailing_bits( ) | |
| } | |

Non-essential SEI messages are not required by the decoding process. Conforming decoders are not required to process this information for output order conformance.

Specification for presence of non-essential SEI messages is also satisfied when those messages (or some subset of them) are conveyed to decoders (or to the HRD) by other means not specified in V3C V-PCC specification (23090-5). When present in the bitstream, non-essential SEI messages shall obey the syntax and semantics as specified in Annex F (23090-5). When the content of a non-essential SEI message is conveyed for the application by some means other than presence within the bitstream, the representation of the content of the SEI message is not required to use the same syntax specified in annex F (23090-5). For the purpose of counting bits, the appropriate bits that are actually present in the bitstream are counted.

Essential SEI messages are an integral part of the V-PCC bitstream and should not be removed from the bitstream. The essential SEI messages are categorized into two types, Type-A essential SEI messages and Type-B essential SEI messages.

Type-A essential SEI messages contain information required to check bitstream conformance and for output timing decoder conformance. Every V-PCC decoder conforming to point A should not discard any relevant Type-A essential SEI messages and shall consider them for bitstream conformance and for output timing decoder conformance.

Regarding Type-B essential SEI messages, V-PCC decoders that wish to conform to a particular reconstruction profile should not discard any relevant Type-B essential SEI messages and shall consider them for 3D point cloud reconstruction and conformance purposes.

U.S. application Ser. No. 16/815,976 filed Mar. 11, 2020, describes several reasons why separation of atlas layouts for different components (such as video encoded components) makes sense. These ideas aim at reducing video bitrates and pixel rates thus enabling higher quality experiences and wider support for platforms with limited decoding capabilities. The reduction of pixel rate and bitrate is mainly possible because of different characteristics of video encoded components. Certain packing strategies may be applied for geometry or occupancy information whereas different strategies make more sense for texture information. Similarly other components like normal or PBRT-maps may benefit from a specific packing design which further increases the opportunities gained by enabling separate atlas layouts.

Examples of application include i) down sampling flat geometries, where in certain conditions scaling down patches representing flat geometries may become viable. This helps in reducing the overall pixel rate required by the geometry channel at minimal impact on output quality; ii) partial meshing of geometry, where instead of signaling depth maps for every patch, it may be beneficial to signal geometry as a mesh for individual patches, thus being able to remove patches from the geometry frame should be considered; iii) uniform color tiles, where in some cases (e.g. Hijack) certain patches may contain uniform values for color data, thus signaling uniform values in the metadata instead of the color tile may be considered. Also scaling down uniform color tiles or color tiles containing smooth gradients may be equally valid; iv) patch merging, where in some cases it may be possible to signal smaller patches inside larger patches, provided that the larger patch contains the same or visually similar data as the smaller patch; v) future proofing MIV+V-PCC, where there may be other non-foreseeable opportunities in atlas packing that require separation of patch layouts. Current designs do not allow taking advantage of such capabilities and some flexibility to packing should be introduced.

Packing color tiles in a way that aligns the same color edges of tiles next to each other may help improving the compression performance of the color component. Similar methods for the depth component may exist but cannot be accommodated because of fixed patch layouts between different components. Providing tools for separating patch layout of different components should thus be considered to provide further flexibility for encoders to optimize packing based on content.

FI Application No. 20205226 filed Mar. 4, 2020 describes signaling information when separation of atlas layouts for video encoded components is used in ISO/IEC 23090-5, such as V3C signaling for a separate patch layout. Below are some examples:

1) New V3C specific SEI messages for V-PCC bitstream, e.g. “separate_atlas_component( )”. In this case, an SEI message is inserted in a NAL stream signaling which component the following or preceding NAL units are applied to. The SEI message may be defined as prefix or suffix. If said SEI message does not exist in the sample atlas_sub_bitstream, NAL units are applied to all video encoded components. This design provides flexibility to signal per component NAL units, which enable signaling different layouts and parameter sets for each video encoded component. The new SEI message should contain at least component type as defined in 23090-5 Table 7.1 V-PCC Unit Types as well as attribute type.

2) Definition of component type in NAL unit header( ). By adding an indication of which video encoded component each NAL unit should be applied to allows flexibility for signaling different atlas layouts. A default value for the component type could be assigned to indicate that NAL units are applied to all video encoded components.

3) Signaling atlas layouts in separate tracks. Implementation of separate tracks of timed metadata per video encoded component describing the patch layout is possible.

4) Signaling mapping of atlas layer to a video component or group of video components. Each atlas layer contains a different patch layout. Each video component or group of video components is assigned to a different layer of an atlas (distinguished by nuh_layer_id). The linkage of atlas nuh_layer_id and a video component can be done on the V-PCC parameter set level (V-PCC unit type of VPCC_VPS), on the atlas sequence parameter level or the atlas sequence parameter level. All the parameter sets have an extensions mechanism that can be utilized to provide such information.

FI Application No. 20205280 filed Mar. 19, 2020 describes methods for packing volumetric video in one video component as well as related signaling information. The signaling methods described herein also contain information about how to separate the signaling of patch information. Below are some examples of the signaling methods.

1) A new vuh_unit_type is defined and a new packed_video( ) structure in vpcc_parameter_set( ) is defined. A new vpcc_unit_type is defined. The packed_video( ) structure provides information about the packing regions.

2) A special use case is implemented where attributes are packed in one video frame. A new identifier is defined that inform a decoder that a number of attributes are packed in a video bitstream. A new SEI message provides information about the packing regions.

3) A new packed_patches( ) syntax structure in atlas_sequence_parameter_set( ) is implemented. Constrains are provided on tile groups of atlas to be aligned with regions of packed video. Patches are mapped based on the patch index in a given tile group. This is a way of interpreting patches as 2D and 3D patches.

4) New patch modes in patch_information_data and new patch data unit structures are defined. Patch data type can be signaled in the patch itself, or the patch is mapped to video regions signaled in a patched_video( ) structure (see 1).

FI Application No. 20205297 filed Mar. 25, 2020 describes a method for packing view-dependent texture information for volumetric video as multiple texture patches corresponding to a single geometry patch, and more generally a method for packing and signaling view-dependent attribute information for immersive video. This enables the renderer to blend between more than one texture per geometry patch, thus more accurately capturing reflections and other view-dependent attributes of the surface.

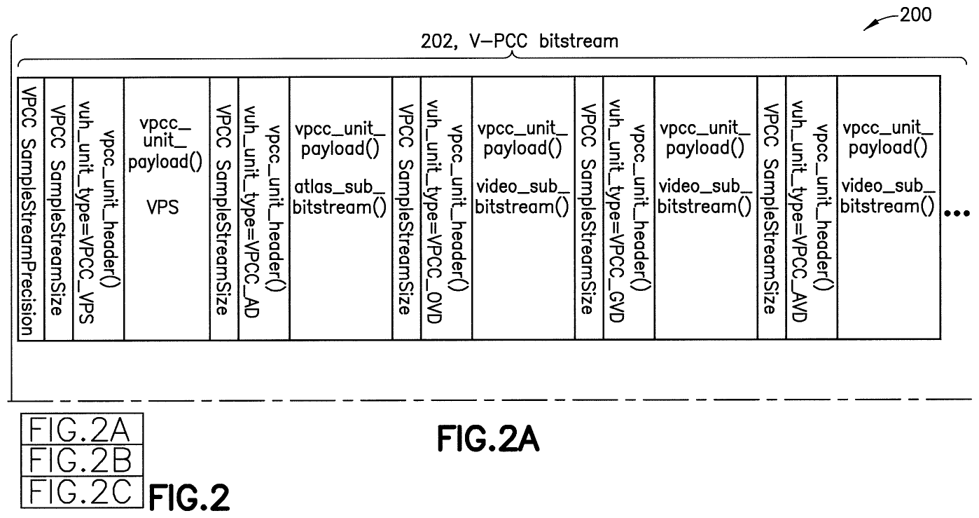

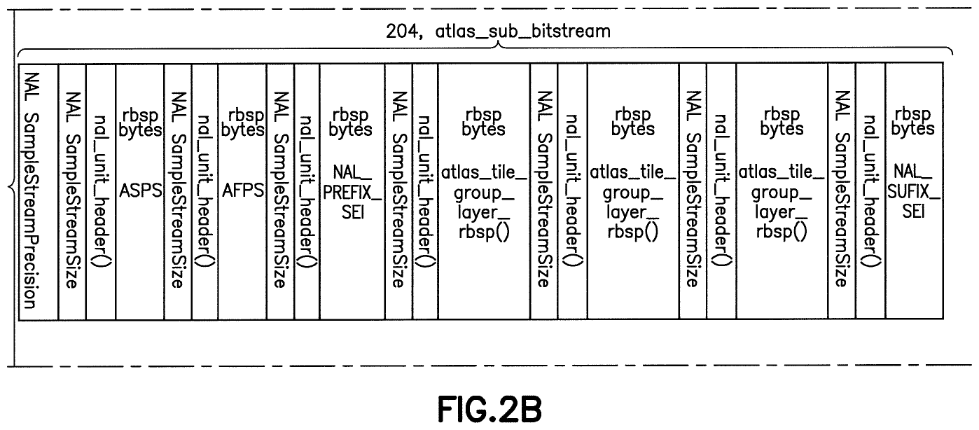

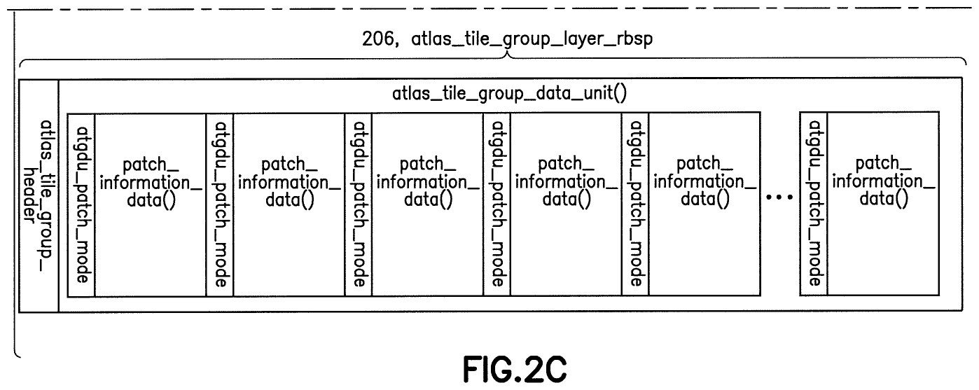

Visual volumetric video-based coding is termed V3C. V3C is the new name for the common core part between ISO/IEC 23090-5 (formerly V-PCC) and ISO/IEC 23090-12 (formerly MIV). V3C is not to be issued as a separate document, but as part of ISO/IEC 23090-5 (expected to include clauses 1-8 of the current V-PCC text). ISO/IEC 23090-12 is to refer to this common part. ISO/IEC 23090-5 is to be renamed to V3C PCC, and ISO/IEC 23090-12 renamed to V3C MIV. FIG. 2 depicts an example V3C bitstream structure 200. Shown in FIG. 2 is the V-PCC bitstream structure 202, the atlas_sub_bitstream structure 204, and the atlas_tile_group_layer_rbsp structure 206.

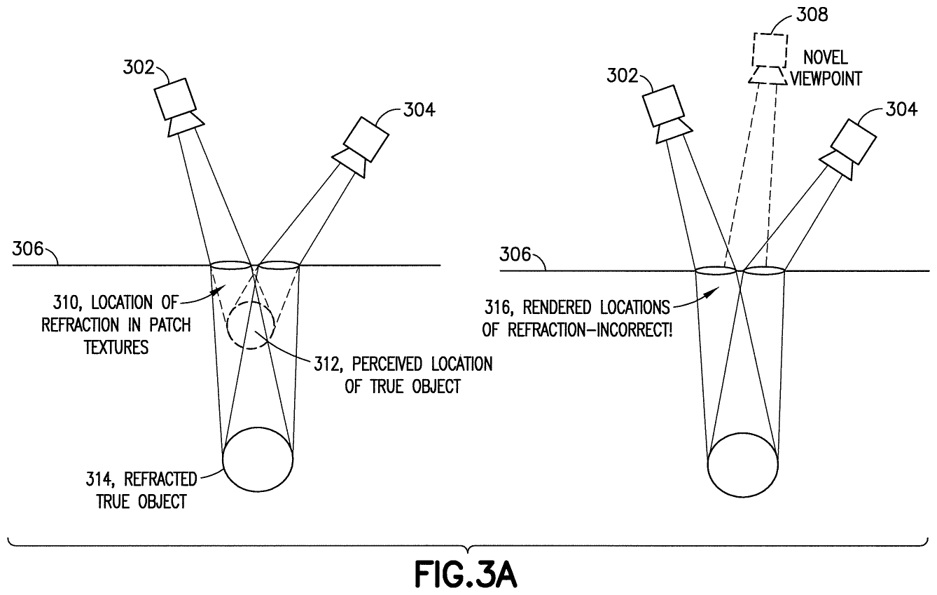

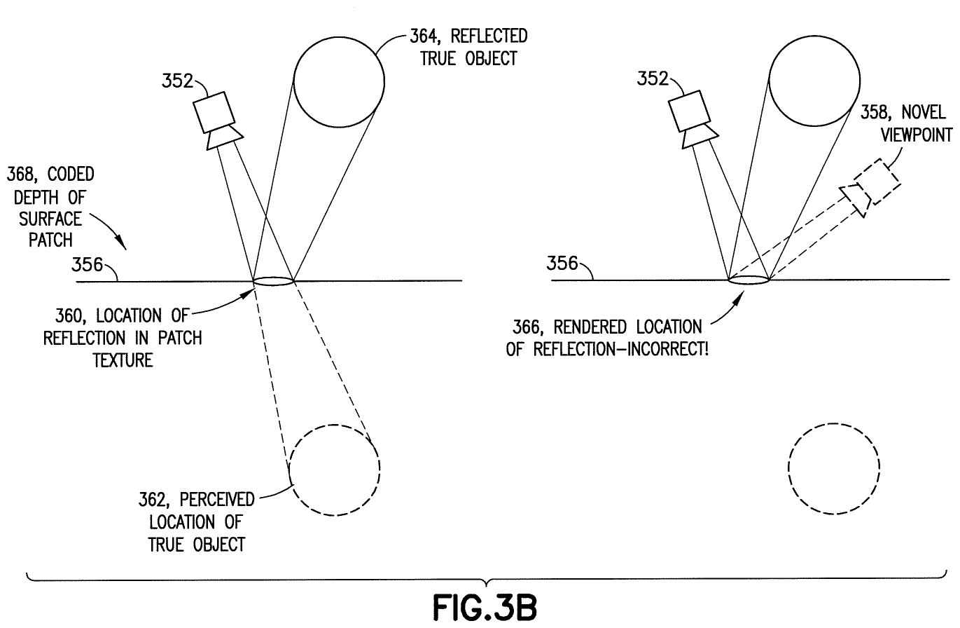

The depth and texture coding of multiple 2D views of a 3D scene discards an important component of the original scene. While the views capture the appearance of objects from multiple angles, the texture in each view can be mapped on the surface of the object. This is incorrect for any object involving reflection or refraction, and a synthesized view cannot produce a correct rendering of such data, as illustrated in FIG. 3A for blending between two encoded views.

A real-world surface such as rippling water can also have a lot of specular highlights that change very rapidly with the position of the viewer, making them impossible to represent using static textures, or require a prohibitively large number of texture patches to model realistically, requiring excessive bitrate and/or rendering performance in practice.

FIG. 3A illustrates the problem of view-dependent texturing demonstrated on a translucent surface. In FIG. 3A, the renderer 302 and renderer 304 represent two different coded views of the surface. Without a depth offset, each view maps the image of the object beyond the surface 306 into a different location on the surface texture, resulting in incorrect rendering.

In particular, FIG. 3A shows the location of refraction in patch textures 310, the perceived location of the true object 312, the refracted true object 314, and the incorrect rendered locations of refraction 316. Novel viewpoint from renderer 308 is also shown.

FIG. 3B illustrates the problem of rendering the location of a reflection. View of renderer 352 is shown, as is novel viewpoint of renderer 358 and surface 356. In particular, FIG. 3B shows a reflected true object 364, the coded depth of the surface patch 368, the location of the reflection in the patch texture 360, the perceived location of the true object 362, and the incorrect rendered location of the reflection 366.

The view-dependent texture signaling method presented in FI Application No. 20205297 filed Mar. 25, 2020 enables more fine-grained representation of such view-dependent attributes and is well suited to signaling reflections on relatively dull surfaces. However, the method becomes less efficient with increased glossiness, as representing sharper reflections requires an increasing number of view-dependent textures. Approaching more mirror-like surfaces such as glass and water still requires an impractical amount of data to be feasible using view-dependent texturing alone.

3D graphics and game engines approach the problem by storing the material parameters of surfaces in the game data and rendering the reflections (or approximations thereof) dynamically at run-time. This is not practical for captured content where the material parameters cannot be easily recovered, the geometry may be inaccurate, and the complexity of the captured scene easily exceeds that of artist-modeled game content.

“Pre-baked” approaches suitable for immersive video are limited to view blending and view-dependent texturing. One example of such techniques is Google Seurat (https://developers.google.com/vr/discover/seurat (last accessed May 5, 2020)).

The examples described herein provide a new patch metadata for signaling view-dependent transformations of the texture component, enabling more realistic rendering of surface effects such as reflection and refraction. The additional metadata consists of a depth offset of the texture layer with respect to the geometry surface, and/or texture transformation parameters.

These new metadata components enable the renderer to offset the texture coordinates of the texture layer depending on the viewing position.

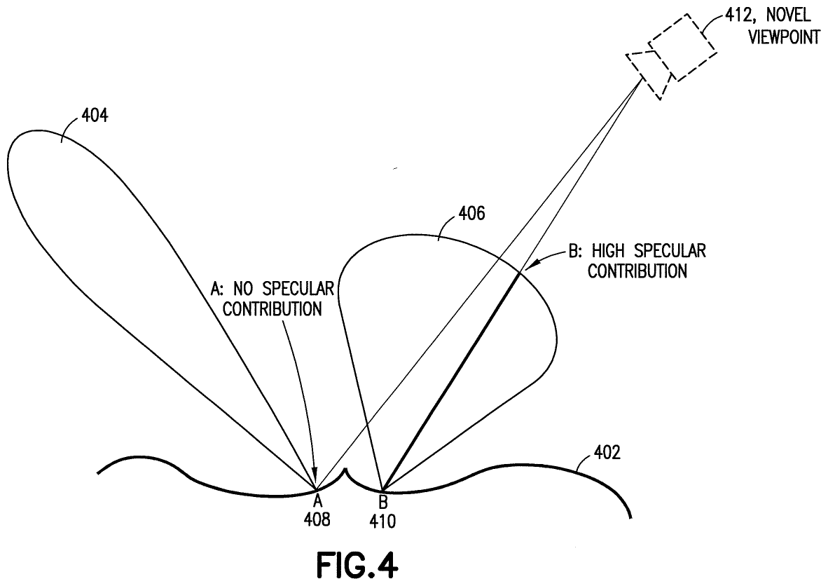

In another embodiment, new patch metadata for signaling specular highlight layers is provided, allowing approximating the appearance of a non-smooth specular surface such as water. Included in this embodiment is the encoding of per-pixel specular lobe metadata, illustrated in FIG. 4, as a texture patch, each pixel corresponding to a 3D point in the associated geometry patch. This allows the renderer to vary the specular highlight contribution on a per-pixel basis according to viewer motion.

Accordingly, FIG. 4 illustrates specular highlight lobes 404 and 406 for two pixels A 408 and B 410 on a complex geometry patch 402. As depicted in FIG. 4, there is no specular contribution from pixel A 408, while there is high specular contribution from pixel B 410. The encoding of per-pixel specular metadata associated with lobes 404 and 406 as a texture patch allows the renderer, such as renderer 412, to provide such varying specular highlight contribution on a per-pixel basis according to viewer motion associated with the renderer 412.

The examples described herein can be used stand-alone, but also in combination with separate atlas layouts (as described in U.S. application Ser. No. 16/815,976 filed Mar. 11, 2020, FI Application No. 20205226 filed Mar. 4, 2020, and FI Application No. 20205280 filed Mar. 19, 2020) or view-dependent texturing (as described in FI Application No. 20205297 filed Mar. 25, 2020) for more powerful functionality.

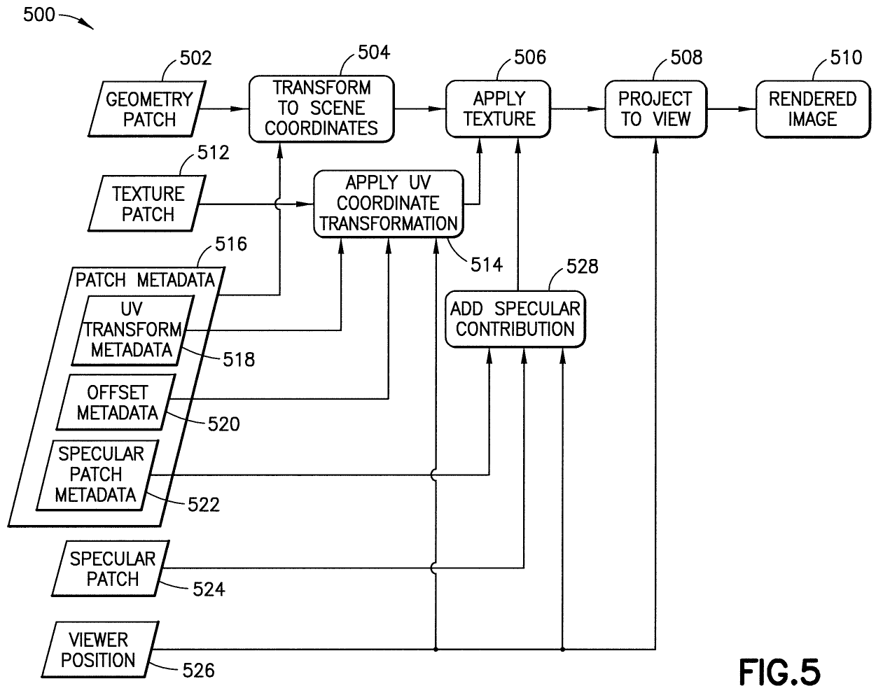

FIG. 5 presents a rendering pipeline 500 implementing the described examples. For a texture patch 512, the new offset metadata 520 and UV transformation metadata 518 enable the renderer to shift the texture according to viewer position 526, resulting in a more convincing rendered image 510 where reflective/refractive surfaces can react to viewer motion. For a specular patch 524, the specular contribution (e.g., refer to Add specular contribution 528) is evaluated per pixel and added on top of all other texture contributions to the final color of the surface. In additional embodiments, multiple texture patches may be present, each with different parameters, and all texture patches are blended to the single geometry patch.

As shown by the pipeline 500 of FIG. 5, the patch metadata 516 includes UV transform metadata 518, offset metadata 520, and specular patch metadata 522. The patch metadata 516 is provided to 504 (transform to scene coordinates), to transform the scene coordinates of the geometry patch 502. In the example shown in FIG. 5, of the patch metadata 516, the UV transform metadata 518 and the offset metadata 520 is provided to 514 (apply UV coordinate transformation), and the specular patch metadata is provided to 528 (add specular contribution). The texture patch 512 and the viewer position 526 are also provided to 514 (apply UV coordinate transformation), and the viewer position 526 and the specular patch 524 is also provided to 528 (add specular contribution).

The result of 504 (transform to scene coordinates) is provided, along with the result of 514 (apply UV coordinate transformation) and result of 528 (add specular contribution) to 506 (apply texture). The result of 506 (apply texture) is provided, along with the viewer position 526 to 508 (project to view). The result of 508 (project to view) is provided to 510 (rendered image) to render the data.

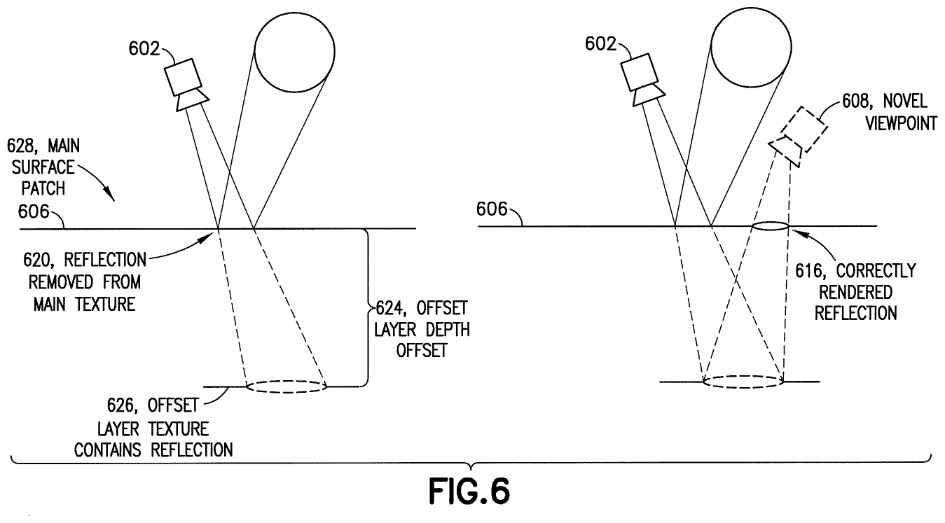

Regarding depth offset metadata, each geometry patch consists of a depth map indicating the shape of the 3D surface belonging to the patch. By default, the texture patch is projected onto that surface, as if painted on the surface. The examples herein provide a new way to signal a texture map that is offset from the surface, as if residing inside or outside of the surface. FIG. 6 illustrates one example of a reflection on a planar surface, where the offset texture patch visually resides beyond the surface, producing an illusion of a mirror-like reflection.

In particular, FIG. 6 depicts an example reflection texture offset from the geometric surface 606. Using the offset information, the renderer is able to adjust the position of the reflection according to the synthesized viewpoint.

Depicted in FIG. 6 is renderer 602 and renderer 608, where renderer 608 has a novel viewpoint. The surface 606 is associated with the main surface patch 628. At 620, the reflection is removed from the main texture. At 626, the offset layer texture contains the reflection. The offset layer depth offset is shown at 624, enabling a correctly rendered reflection at 616.

In the case of FIG. 6, a simple per-patch offset 624 indicates the depth of the texture relative to the geometric surface 606. Before applying the texture to the surface being rendered, the renderer may use the geometric relationship resulting from the depth offset 624, the original renderer 602 position, and the position of the synthesized viewpoint (represented by renderer 608) to compute the proper UV coordinate offset to apply to the projected texture coordinates of the offset texture.

For this, the necessary signaling consists of a single depth offset in suitable scene depth units, which may be called patch_texture_depth_offset and it could be transmitted within patch_information_data( ), e.g. in a patch_data_unit( ) structure as well as in any other patch data type structure defined in the ISO/IEC 23090-5 specification.

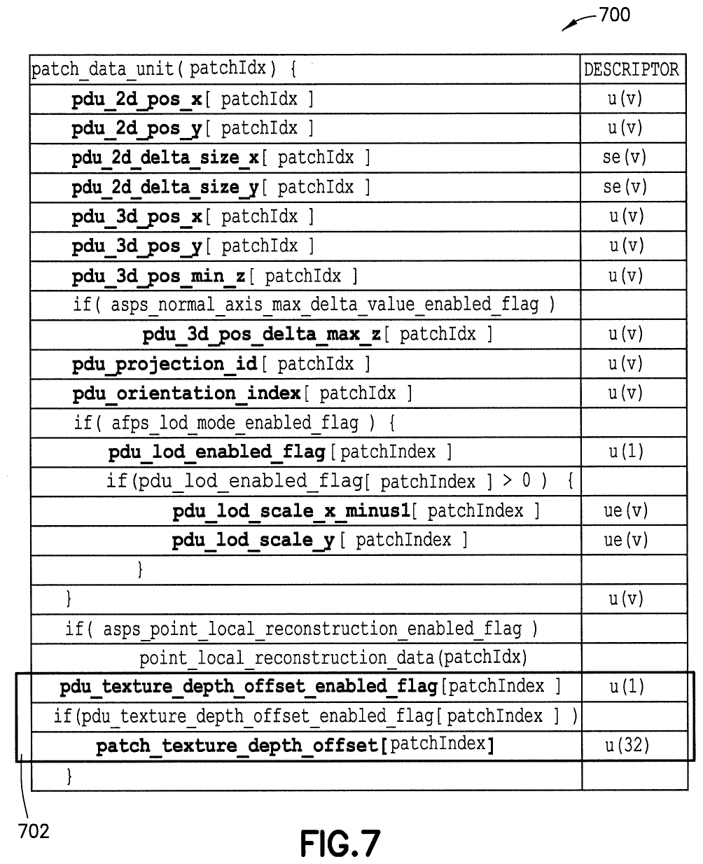

For example, FIG. 7 shows such an example 700 of signaling a single depth offset in suitable scene depth units within a patch data unit structure, namely patch_data_unit. The example patch data unit structure of FIG. 7 is also shown below:

| | Descriptor |
|---|---|
| patch_data_unit( patchIdx ) { | |
| pdu_2d_pos_x[ patchIdx ] | u(v) |
| pdu_2d_pos_y[ patchIdx ] | u(v) |
| pdu_2d_delta_size_x[ patchIdx ] | se(v) |
| pdu_2d_delta_size_y[patchIdx ] | se(v) |
| pdu_3d_pos_x[ patchIdx ] | u(v) |
| pdu_3d_pos_y[ patchIdx ] | u(v) |
| pdu_3d_pos_min_z[ patchIdx ] | u(v) |
| if( asps_normal_axis_max_delta_value_enabled | |
| _flag ) | |
| pdu_3d_pos_delta_max_z[ patchIdx ] | u(v) |
| pdu_projection_id[ patchIdx ] | u(v) |
| pdu_orientation_index[ patchIdx ] | u(v) |
| if( afps_lod_mode_enabled_flag ) { | |
| pdu_lod_enabled_flag[ patchIndex ] | u(1) |
| if( pdu_lod_enabled_flag[ patchIndex ] > 0 ) | |
| { | |
| pdu_lod_scale_x_minus1[ patchIndex ] | ue(v) |
| pdu_lod_scale_y[ patchIndex ] | ue(v) |
| } | |
| } | u(v) |
| if( | |
| asps_point_local_reconstruction_enabled_flag ) | |
| point_local_reconstruction_data( patchIdx ) | |
| pdu_texture_depth_offset_enabled_flag[ | u(1) |
| patchIndex ] | |
| if( pdu_texture_depth_offset_enabled_flag[ | |
| patchIndex ] ) | |
| patch_texture_depth_offset[ patchIndex | u(32) |
| ] | |
| } | |

Highlighted in FIG. 7 is the novel depth offset signaling 702. The example depth offset signaling 702 may be used for texture, as shown, as well as for attributes other than texture.

Alternatively, patch_texture_depth_offset could be transmitted as a SEI message that provides such additional information for every patch.

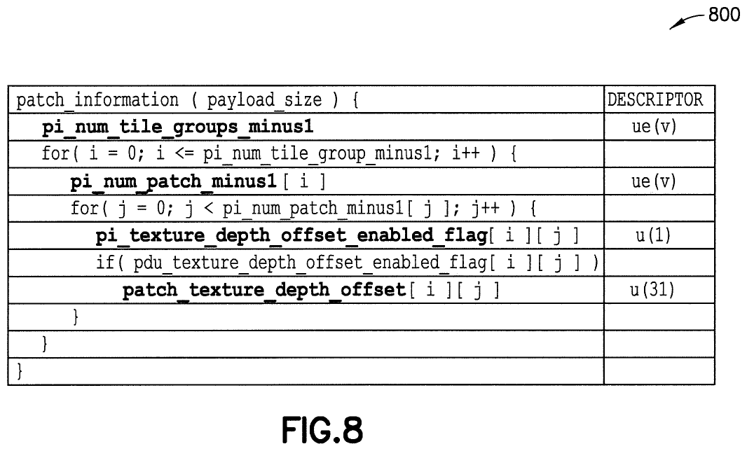

FIG. 8 shows such an example of signaling a single depth offset in suitable scene depth units as an SEI message 800. The SEI message is also shown below:

| | Descriptor |
|---|---|
| patch_information ( payload_size ) { | |
| pi_num_tile_groups_minus1 | ue(v) |
| for( i = 0; i <= pi_num_tile_group_minus1; | |
| i++ ) { | |
| pi_num_patch_minus1[ i ] | ue(v) |
| for( j = 0; | |
| j < pi_num_patch_minus1[ j ]; j++ ) { | |
| pi_ | u(1) |
| texture_depth_offset_enabled_flag [ i ][ j ] | |
| if( | |
| pdu_texture_depth_offset_enabled_flag[ i ][ j ] ) | |
| patch_texture_depth_offset | u(31) |
| [ i ] [ j ] | |
| } | |
| } | |
| } | |

While texture is referred to above, the offset could be applied to any other patch attribute.

The depth offset of the offset layers may also vary per pixel. In the case of FIG. 6, for example, the shape of the reflected object could be approximated with another depth map. In this description, the term “offset geometry patch” is used to refer to such an additional depth map. Such offset geometry patches could be transmitted as a separate video encoded component and have its own identifier for ai_attribute_type_id as defined in ISO/IEC 23090-5. For this purpose, patch_texture_depth_offset may be complemented with another syntax element, patch_texture_depth_range, which indicates the range of depth values represented by the offset geometry patch. The patch_texture_depth_range could be transmitted along patch_texture_depth_offset within patch_information_data( ), e.g. in patch_data_unit( ) as well as in any other patch data type structure defined in the ISO/IEC 23090-5 specification, or a newly defined SEI message.

The rendering algorithm for an offset geometry patch may work by first offsetting the UV coordinates based on patch_texture_depth_offset, then iteratively sampling the offset geometry patch starting from that location until a suitable approximation of the accurate per-pixel intersection with the offset geometry patch surface is found.

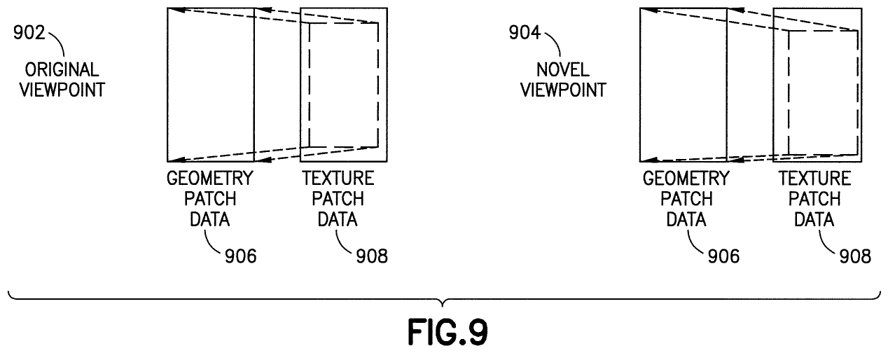

Dynamic UV offset metadata may also be implemented. In addition to a geometric depth offset, a UV coordinate transformation may be signaled to simulate different kinds of reflection and refraction effects. FIG. 9 illustrates a case where a UV coordinate shift is desired depending on viewer motion.

Accordingly, FIG. 9 depicts an example reflection texture offset from the geometric surface. In particular, shown in FIG. 9 is geometry patch data 906 and texture patch data 908 from the original viewpoint 902, and the geometry patch data 906 and texture patch data 908 from the novel viewpoint 904, such that the novel viewpoint 904 implements the depth offset.

In an embodiment, additional parameters may be signaled to achieve such a dynamic, view-dependent texture animation. Example parameters include texture translation parameters T, which may include 1) constant U and V bias to apply to the main layer texture coordinates U and V, and 2) dynamic U and V offsets signaling how much the offset layer UV must be shifted relative to a deviation of the viewing ray from the encoded projection ray of the corresponding surface pixel.

Parameters may also include texture scale parameters S, which may include 1) constant texture scale (U and V), and/or 2) a function of view ray deviation for the translation coefficients.

Thus, given initial base layer texture coordinates t (based on projective texturing of the patch based), shifted texture coordinates t′ may be derived as t′=S·t+T, where S and T are the scale and translation parameters as described above.

Using the mechanisms described in previous embodiments, it is possible to define multiple offset textures per patch, each having different parameters, including multiple offset texture layers. This enables encoding of more complex reflections consisting of multiple visual layers, for example, or otherwise intersecting view-dependent effects.

The rendering algorithm for multiple layers may be implemented so that it evaluates the texture depth and UV position for each offset layer, then applies the closest to the pixel currently being rendered.

In another embodiment, the offset geometry patch may also contain an occupancy map, which may be binary or non-binary, or the offset texture patch may contain an alpha channel. Either of these may be used to weight the contribution of the offset texture patch so that offset patches behind the first one may be visible.

In another embodiment, an additional blending mode may be signaled to indicate how to apply each texture layer. Alternatives may include, for example, alpha blending (based on occupancy or a dedicated alpha channel), additive blending, modulation (multiplication), or subtractive blending.

Per-pixel specular highlight signaling may also be implemented. Similarly to how normal maps may be stored in image data, a pixel containing specular information has three components which, according to the examples described herein, may be used to signal a per-pixel 3D vector, each vector corresponding to a point on a 3D surface represented by the associated geometry patch. As opposed to signaling of normal maps, the direction of that vector gives the peak direction of the specular component for that pixel, while the magnitude of the vector signals the shape and/or intensity of the specular contribution.

For each pixel, the specular color contribution S may be derived as:

S=C intensity(|s|)max(0,dot(s/|s|,v))^{power(|s|)}

where C is the (peak) specular color for the patch, s is the specular vector value stored in the specular patch, and v is the normalized viewing direction vector. The functions intensity( ) and power( ) are mapping functions from the specular vector magnitude to peak specular intensity and specular power, respectively. The functions max and dot are the maximum function and dot product function, respectively.

In one embodiment specular vector information may be stored as a new video data component in the V3C elementary stream by reserving a new component type in V3C as described in Table 1. The same patch layout may be used as for other video data components, or techniques, such as those presented in FI Application No. 20205226 filed Mar. 4, 2020, and FI Application No. 20205280 filed Mar. 19, 2020, may be used to enable different layouts and packing options.

For the patch metadata, it is enough to signal a few pieces of metadata. Metadata that may be signaled include the specular color C: e.g. 8-bit RGB components, or floating-point color to signal a high dynamic range maximum intensity. Other types of metadata that may be signaled include the intensity and power mapping functions, alternatives including but not limited to: constant value: f(x)=c, linear mapping: f(x)=cx, power mapping: f(x)=x^{P}, or in an optional embodiment, a clamping flag to signal whether the intensity should be clamped (e.g., to one) prior to modulating with the color C or not. This allows better approximation of certain kinds of reflections.

Note that by specifying a different mapping function for intensity and power, various specular highlight distributions can be approximated over the surface of the patch, and the best mapping can be selected for each patch.

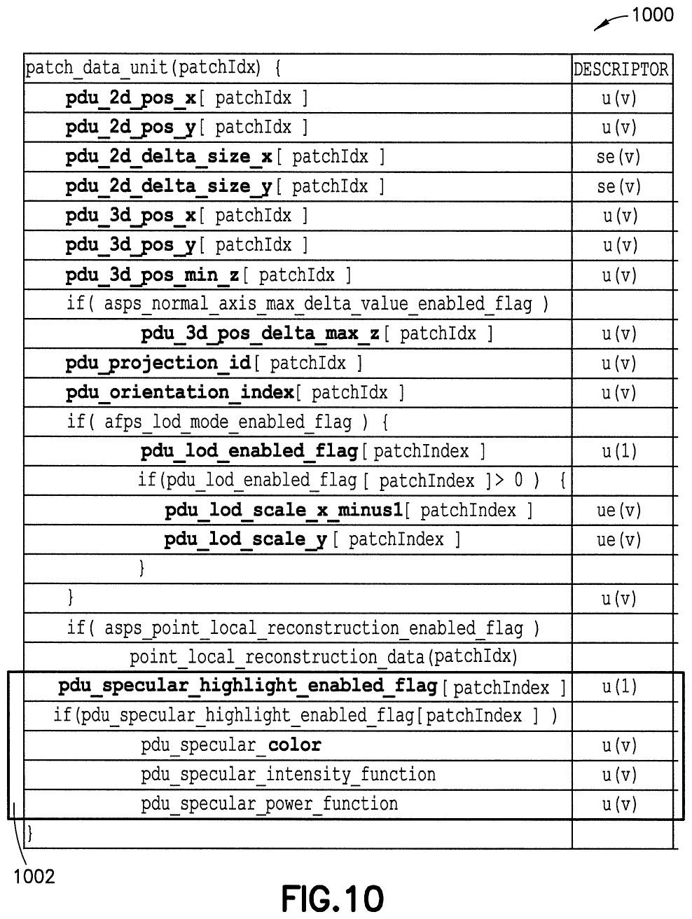

These metadata values could be transmitted within patch_information_data( ), e.g. in the patch_data_unit( ) structure as well as in any other patch data type structure defined in the ISO/IEC 23090-5 specification. FIG. 10 shows example signaling of specular metadata values within a patch data unit structure 1000. The example of FIG. 10 is also shown below:

| | Descriptor |
|---|---|
| patch_data_unit( patchIdx ) { | |
| pdu_24_pos_x[ patchIdx ] | u(v) |
| pdu_2d_pos_y[ patchIdx ] | u(v) |
| pdu_2d_delta_size_x[ patchIdx ] | se(v) |
| pdu_2d_delta_size_y[ patchIdx ] | se(v) |
| pdu_3d_pos_x[ patchIdx ] | u(v) |
| pdu_3d_pos_y[ patchIdx ] | u(v) |
| pdu_3d_pos_min_z[ patchIdx ] | u(v) |
| if( asps_normal_axis_max_delta_value_enabled | |
| _flag ) | |
| pdu_3d_pos_delta_max_z[ patchIdx ] | u(v) |
| pdu_projection_id[ patchIdx ] | u(v) |
| pdu_orientation_index[ patchIdx ] | u(v) |
| if( afps_lod_mode_enabled_flag ) { | |
| pdu_lod_enabled_flag[ patchIndex ] | u(1) |
| if( pdu_lod_enabled_flag[ patchIndex ] > 0 ) | |
| { | |
| pdu_lod_scale_x_minus1[ patchIndex ] | ue(v) |
| pdu_lod_scale_y[ patchIndex ] | ue(v) |
| } | |
| } | u(v) |
| if( | |
| asps_point_local_reconstruction_enabled_flag ) | |
| point_local_reconstruction_data( patchIdx ) | |
| pdu_specular_highlight_enabled_flag[ | u(1) |
| patchIndex ] | |
| if( pdu_specular_highlight_enabled_flag[ | |
| patchIndex ] ) | |
| pdu_specular_color | u(v) |
| pdu_specular_intensity_function | u(v) |
| pdu_specular_power_function | u(v) |
| } | |

Shown in FIG. 10 is the novel specular highlight distribution metadata 1002 implemented within the patch data unit structure 1000.

pdu_specular_color indicates a static value for the specular color component. pdu_specular_color may be stored in any format that describes color, like 8 bit RGB or floating point values.

pdu_specular_intensity_function indicates the type of function, which should be used for intensity, when sampling the final color of the specular reflection. Different indicators for function types may be used, like constant, linear, exponential or other preferred function.

pdu_specular_power_function indicates the type of function, which should be used for power, when sampling the final color of the specular reflection. Different indicators for function types may be used, like constant, linear, exponential or other preferred function.

Per-pixel specular color may also be implemented. In this other embodiment, the specular highlight color may be signaled per-pixel as yet another video data component in the V3C elementary stream by reserving a new component type in V3C as described in Table 1.

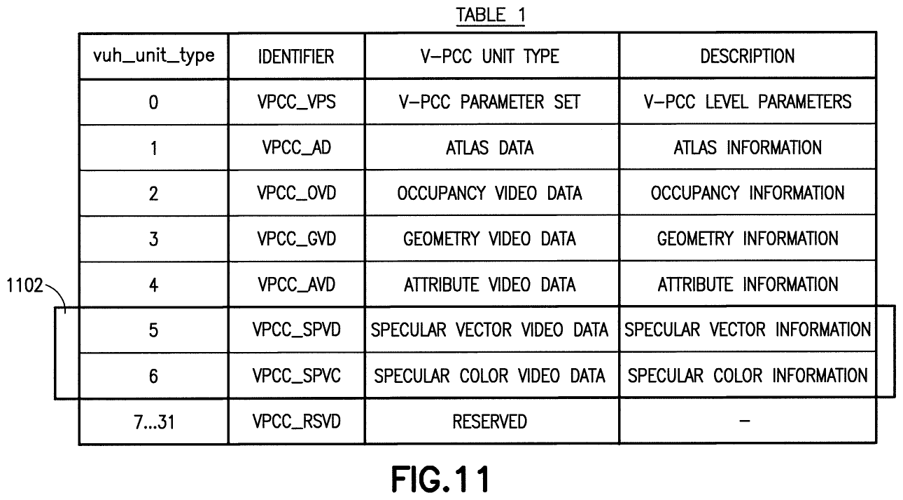

FIG. 11 shows Table 1 (also shown below), highlighting new component types 1102 for specular vector and color.

TABLE 1

| vuh_unit_ | | V-PCC | |
|---|---|---|---|
| type | Identifier | Unit Type | Description |
| 0 | VPCC_VPS | V-PCC | V-PCC level |
| | | parameter | parameters |
| | | set | |
| 1 | VPCC_AD | Atlas data | Atlas |
| | | | information |
| 2 | VPCC_OVD | Occupancy | Occupancy |
| | | Video | information |
| | | Data | |
| 3 | VPCC_GVD | Geometry | Geometry |
| | | Video | information |
| | | Data | |
| 4 | VPCC_AVD | Attribute | Attribute |
| | | Video | information |
| | | Data | |
| 5 | VPCC_SPVD | Specular | Specular |
| | | Vector | vector |
| | | Video | information |
| | | Data | |
| 6 | VPCC_SPVC | Specular | Specular |
| | | Color | color |
| | | Video | information |
| | | Data | |
| 7 . . . 31 | VPCC_RSVD | Reserved | — |

The same patch layout may be used as for other video data components, or techniques, as presented in FI Application No. 20205226 filed Mar. 4, 2020, and FI Application No. 20205280 filed Mar. 19, 2020, may be used to enable different layouts and packing options.

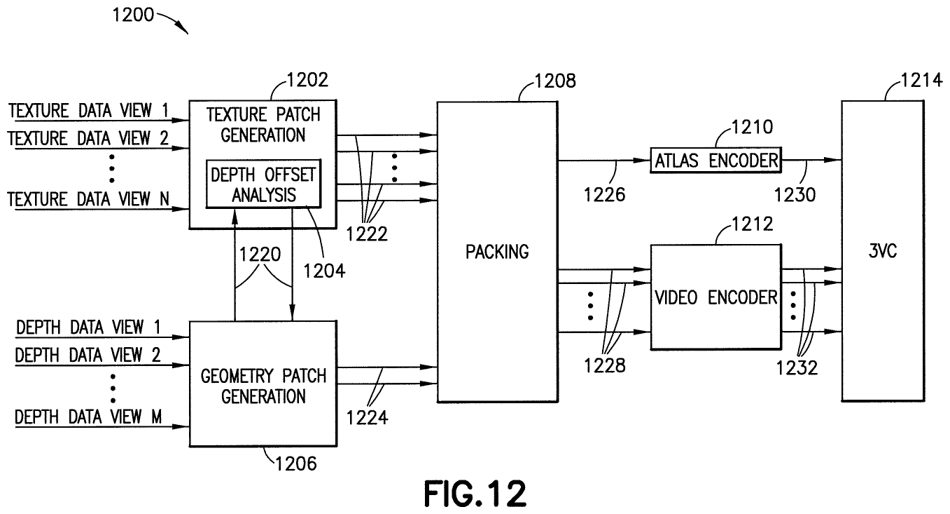

The examples described herein also provide encoding embodiments. In the encoder, the input is likely to be multiple source cameras with geometric depth information. The encoding algorithm at high level may proceed as in the volumetric video coding general multi view encoding description 1200 as described and shown in FIG. 12, but as an additional step 1204, the depth of offset layers may be found using techniques such as depth sweeping: having a geometry patch, the encoder may sweep over a range of depth offset values, project the source camera views to those depths, and find the candidate depths that produce the best match between the projected source camera textures. Depth offset values may be either signaled in metadata of the atlas or as an additional per pixel depth map, 1224. These offset values can then be used for placing the offset layers. A similar strategy may be employed to optimize the texture transformation parameters to improve the match between textures.

The multi view encoding description 1200 is made up of several components. Several texture data views 1, 2, . . . N are provided to texture patch generation 1202, which includes depth offset analysis 1204. Several depth data views 1, 2, . . . M are provided to geometry patch generation 1206. The texture patch generation 1202 and geometry patch generation 1206 have a bidirectional connection via interfaces 1220, or otherwise provide information to each other via 1220. Texture patch generation 1202 provides one or more results to packing 1208 via 1222, and geometry patch generation 1206 provides one or more results, such as a per pixel depth map, to packing 1208 via 1224. As shown in FIG. 12, Packing 1208 provides a result to atlas encoder 1210 via 1226, and packing 1208 provides one or more results to video encoder 1212 via 1228. Atlas encoder 1210 provides a result to V3C 1214 via 1230, and video encoder 1212 provides one or more results to V3C 1214 via 1232.

In the case of CGI inputs, the offset layer parameters can in some cases be derived purely analytically, for example in the case of planar mirrors.

In an embodiment, the rendering process for multiple offset layers and specular highlight layers may proceed as follows:

1. Determine an intersection of a viewing ray and a main surface as in normal view-based rendering.

2. Compute UV coordinates of the main texture using projective texturing.

3. For each offset layer: a. compute a 2D measure of viewing ray deviation (VRD) from the projection ray of the main layer pixel; b. apply static translation and scale parameters to the UV of the offset layer; c. find a second intersection between the viewing ray and the offset layer based on the depth offset of the offset layer, and shift its UV according to the VRD; d. apply translation parameters for a further UV shift according to the VRD; e. fetch the color and occupancy samples from the final UV coordinate of the offset layer; and f. apply the dynamic occupancy parameters according to the VRD.

4. Blend the offset layer with the main layer according to the final occupancy value.

5. For each specular highlight layer: a. evaluate the specular contribution intensity per pixel based on the specular vector direction and magnitude mapping functions; b. modulate with the per-patch specular color or a color sampled from a signaled specular color texture; and c. add the contribution to the texture color accumulated from previous texture and specular layers.

Separation of patch layouts may also be implemented. The examples described herein may be used in combination with separation of patch layouts for one or more video components (refer to U.S. application Ser. No. 16/815,976 filed Mar. 11, 2020, FI Application No. 20205226 filed Mar. 4, 2020, FI Application No. 20205280 filed Mar. 19, 2020). This enables use cases such as encoding different reflection layers at different resolutions: for example, a surface that has sharp, high-frequency surface texture mixed with a glossy reflection of the surroundings; or reflections of multiple objects at different distances, where one object may have high-frequency details (such as tree branches) while another has smoothly varying colors (a sky in the background).

Signaling of view-dependent textures may also be implemented. The examples described herein may also be used in combination with view-dependent textures (refer to FI Application No. 20205297 filed Mar. 25, 2020). This enables yet more compelling reflection effects, as well as overcoming a major limitation of view-dependent texturing by enabling the view-dependent textures to be interpolated in content, and position as well. This allows matching of the view-dependent texture positions across the range of interpolated views between source cameras, and thus the number of view-dependent textures required to achieve a sharp reflection is greatly reduced.

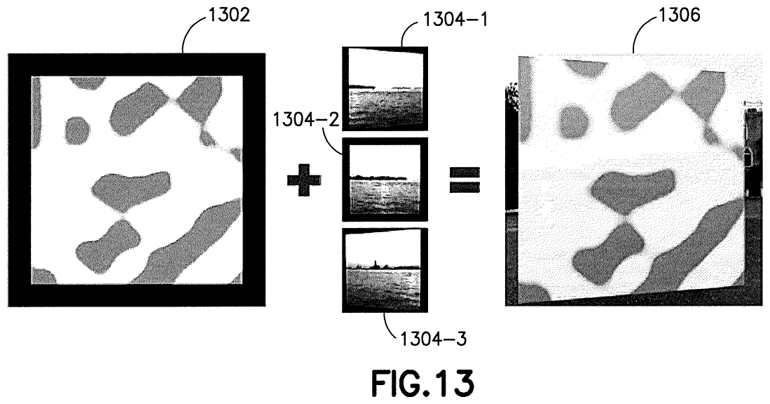

FIG. 13 illustrates an example of adding a specular contribution 1302 to a plurality of layers (namely layer 1304-1, layer 1304-2, and layer 1304-3) to generate result 1306.

The examples described herein further relate to multi-layer volumetric content for immersive video and volumetric video coding, where dynamic 3D objects or scenes are coded into video streams for delivery and playback. The MPEG standards V-PCC (Video-based Point Cloud Compression) and MIV (Metadata for Immersive Video) are two examples of such volumetric video compression, sharing a common base standard V3C.

In V3C, the 3D scene is segmented into a number of regions according to heuristics based on, for example, spatial proximity and/or similarity of the data in the region. The segmented regions are projected into 2D patches, where each patch contains at least surface texture and depth channels, the depth channel giving the displacement of the surface pixels from the 2D projection plane associated with that patch. The patches are further packed into an atlas that can be streamed as a regular 2D video.

A characteristic of MIV, in particular, that relates to the examples described herein is that each patch is a (perspective) projection toward a virtual camera location, with a set of such virtual camera locations residing in or near the intended viewing region of the scene in question. The viewing region is a sub-volume of space inside which the viewer may move while viewing the scene. Thus, the patches in MIV are effectively small views of the scene. These views are then interpolated (e.g., a between interpolation) in order to synthesize the final view seen by the viewer.

A problem of the color-and-depth representation is that the depth values represent a single surface distance at each pixel of the encoded patches. This is adequate for representing opaque objects, but volumetric participating matter such as fog or dust in the air cannot be represented. While the multi-view representation inherent to MIV can include all visual information seen from the virtual camera location of each patch, encoding complex volumetric effects such as smoke may require an impractically dense arrangement of virtual camera locations in order to avoid interpolation artifacts. Also, the pre-baked nature of the encoded views does not allow for new 3D objects to be embedded into the scene in a natural way, which would be desirable in many applications.

Traditionally, graphics APIs such as OpenGL and Direct3D (D3D) have supported a global “fog” attribute that causes a constant color to be blended on top of the rendered surface proportionally to surface distance from the camera. Parameters enable specifying constant, linear, and exponential distance-based blending coefficients, and the parameters can be varied per draw call. This basically allows for simulation of completely uniform fog or participating matter under flat illumination, but any more detailed volumetric effects are impossible to render.

In contemporary computer games and simulations, volumetric matter has typically been represented using solid modeling such as 3D “fog volumes” placed in the scene, or with translucent 2D impostors of, e.g., smoke clouds.

Fog volumes typically have uniform density inside each individual volume, making modeling of more complex phenomena difficult. However, effects such as light scattering can be modeled by raymarching through the volume and summing light contributions along the way.

2D impostors or point sprites allow for finer details, but with a trade-off between the amount of impostors that can be rendered and the realism of the resulting effect. Also, lighting cannot be simulated as accurately as with fog volumes.

A voxel representation can be used to model complex volumetric data at a desired resolution, but rendering from voxel is yet more expensive, and voxel data does not typically compress well enough compared to the patch-based volumetric video.

The examples described herein include adding a volumetric media layer to immersive video coding via three main embodiments: first, adding an explicit volumetric media layer; second, adding volumetric media attributes to coded 2D patches; and third, adding volumetric media via separate “volumetric media view” patches.

In the first embodiment, a volumetric media data type is introduced as a 3D grid of samples that is coded as layered 2D image tiles in a video atlas at a lower resolution than the main media content. This enables representation of smoothly varying participating matter.

In the second embodiment, the already coded 2D view patches are extended with fog attributes that enable OpenGL/D3D-like fog attributes per pixel, allowing fog color and density to vary across the patch.

In the third embodiment, the fog attributes are separated into their own views and patches storing the fog parameters. The fog views have a different spatial layout from the main texture and depth patches, enabling more efficient encoding of the volumetric data.

Per the examples described herein, the volumetric video is split into two different components: a volumetric video component, as already represented by the MPEG Immersive Video standard for example; and a volumetric participating matter (or fog) component that may be composited together with the final synthesized volumetric video view. A practical implementation may combine the fog component into the main view synthesizer, but at a conceptual level the compositing can be thought of as a separate step.

At each point along a viewing ray r in a 3D volume of participating matter, light is divided into a component passing directly through the point, and a component that results from inscattering from other directions. An immersive video without volumetric attributes represents the direct component, i.e., the primary viewing ray of light r emanating from the scene geometry and hitting the receiving (virtual or real) camera at the viewing location. The scattering component can be modeled as a function s(p, θ, φ), giving the radiance scattered from 3D point p toward the direction given by the angles θ and φ. Similarly, a function a(p, θ, φ) can model the attenuation of the primary viewing ray due to absorption and outscattering at each 3D point p. By integrating the functions s and a over the ray r, the contributions of inscattering and attenuation can be applied on top of the primary color of the background geometry.

In a practical implementation, the functions s and a may be approximated with simpler (not physically based) functions, by discretely sampling the values of physically based functions over positions and directions, or a combination of both. A previous disclosure, U.S. application Ser. No. 15/958,005 filed Apr. 20, 2018, describes methods for approximation of spherically distributed illumination functions in a 3D voxel grid, and similar methods can be applied here.

### Embodiment 1a: Volume Grid of Illumination & Attenuation Samples

For the following example, it is assumed that s and a are simplified to a uniform RGB radiance (emitting the same scattered radiance in all directions), and a uniform attenuation coefficient A (modulating a viewing ray passing through the volume equally regardless of direction). This data can be sampled into a 3D grid of RGBA values to produce a volume texture of the participating matter. This volume texture may be relatively uniform so it compresses well using a video codec.

The volume texture may then be split into slices, for example along the Z axis of the volume, and each slice may be encoded as an image tile in a video atlas, similarly to the primary geometry and texture patches of the original volumetric video. Due to the smooth nature of the data, this volume texture can be at a reduced resolution, so the amount of data can stay reasonable.

The stack of slices may be associated with metadata indicating the position of the volume texture in the scene coordinate system. The position of the volume texture may be described by defining minimum and maximum coordinates of the volume. Indication of the slicing axis for the volume texture may provide additional flexibility and encoding efficiency. The following syntax elements may be used to define coordinates for the volume texture.

| | Descriptor |
|---|---|
| volume_texture( ) { | |
| min_pos_x | float(32) |
| min_pos_y | float(32) |
| min_pos_z | float(32) |
| max_pos_x | float(32) |
| max_pos_y | float(32) |
| max_pos_z | float(32) |
| slicing_axis | u(3) |
| } | |

min_pos_x, min_pos_y and min_pos_z indicate the minimum values for the volume in the scene coordinate system as 32 bit floating point values.

max_pos_x, max_pos_y and max_pos_z indicate the maximum values for the volume in the scene coordinate system as 32 bit floating point values. The area between maximum and minimum values indicates the rectangular area of the volume in the scene.

slicing_axis indicates the scene direction in which the slices are stacked. slicing_axis==0 shall be interpreted as positive x-axis, slicing_axis==1 shall be interpreted as positive y-axis, slicing_axis==2 shall be interpreted as positive z-axis, slicing_axis==3 shall be interpreted as negative x-axis, slicing_axis==4 shall be interpreted as negative y-axis and slicing_axis==5 shall be interpreted as negative z-axis.

In other embodiments, the slicing axis may be indicated with a 3D direction vector instead of cardinal directions, or the negative axis directions omitted, and the cardinal direction indicated with just two bits, for example.

The volume texture may be encoded as part of other scene elements and share the same atlas. In which case the patch data contains additional information about the type of content the patch contains. The bare minimum would be to indicate if a patch contains volume data or geometry data. In case the patch contains volumetric data, the slice id of the volumetric patch is included. A slice id indicates the order of volumetric patches in the slicing_axis direction. Regarding V-PCC the RGBA volume texture values may be encoded attribute video data (RGB) and geometry video data (A). The volume_texture( ) structure may be signaled as part of sequence or frame level parameters. Alternatively, a SEI message may be defined to signal volume_texture( ).

Regarding MIV, a similar bitstream embedding approach may be used. The volume_texture( ) structure may be signaled as part of the bitstream by appending volume texture patches in patch_parameters_list( ). Alternatively a SEI message may be defined or a new component type may be specified. Such an example configuration is a patch( ) structure as shown below.

| | Descriptor |
|---|---|
| patch( ) { | |
| /* already defined patch data */ | |
| patch_type | u(1) |
| slice_id | u(8) |
| } | |

patch_type indicates the type of patch. patch_type==0 is used for normal patches. patch_type==1 is reserved for volume texture patches.

slice_id provides the slice_id for volume texture patches, which indicates the patch stack order in the volume. A view_id attribute in patch parameters may be reused to signal slice_id if patch_type is known.

If volume texture is encoded as a separate track, the size of volume texture slices are defined. This indicates how the volume texture is packed in a video frame. The slices may be packed in the video frame in slice order starting by filling the first row and then proceeding to fill the rest of the rows. This negates the need to signal the slice id. The volume_texture( ) itself may be stored in its track header, metadata box, user data box, sample group description box, sample description box or similar file-format structure. An example volume_texture( ) structure is shown below.

| | Descriptor |
|---|---|
| volume texture( ) { | |
| min_pos_x | float(32) |
| min_pos_y | float(32) |
| min_pos_z | float(32) |
| max_pos_x | float(32) |
| max_pos_y | float(32) |
| max_pos_z | float(32) |
| slicing_axis | u(3) |
| slice_width | u(16) |
| slice_height | u(16) |
| } | |

slice width indicates the width of a volume texture slice in the frame.

slice height indicates the height of a volume texture slice in the frame.

During rendering, the client may use a raymarching algorithm to step through the volume texture, collecting the contributions from the volume texture and applying them on top of the basic color synthesized by view interpolation of the primary texture patches. The fog contributions may be interpolated when sampling them from the 3D grid to alleviate blocking artifacts.

### Embodiment 1b: Video Coding of Volumetric Layers

Since the fog volume is often changing more slowly than the main scene content, it may be updated less frequently. This and the fact that the data is smooth open a possibility to encode the volumetric grid in less (texture atlas) space than the tiled approach of embodiment 1a. Instead of laying out the individual volume layers spatially in a single video frame, they can be placed in consecutive frames instead.

The volumetric object may then either update a slice at a time as new data is decoded, or a snapshot of the previous volume may be kept in the client until a new volume is fully received, after which it is updated by interpolating over time to avoid jumping artefacts. In the latter case, the volumetric video should be sent offset forward in time by the number of frames corresponding to the number of layers so that the complete volume is available to the client at the right time.

### Embodiment 2a: View-Based Fog Parameters

Alternatively, the fog coding can be tied with the view-based coding of the content. Especially since the V3C format allows multiple attribute channels over patches, the fog parameters can be signaled in such additional attribute patches.

For example, the fog color and density can be signaled as an RGBA texture patch, with the RGB components capturing the fog color and A the density. This texture can then be composited on top of the scene using the traditional computer graphics fog model, based on the depth of the scene elements in the view.

FI Application No. 20205226 filed Mar. 4, 2020 describes signaling of different layouts and other settings depending on the component type or attribute type. Ideas covered therein may be used to signal patches that relate to volumetric textures or fog. As an example, an SEI message may be used precede list of fog related patches to provide the needed functionality. This requires defining new component type for storing volumetric textures. As an example, vuh_unit_type of 5 may be used. The value for the new component type should not conflict with values described in table 7.1 in 23090-5.

A benefit of a view-based encoding of the fog data is that the fog parameters can be interpolated across views similarly to the base texture. Thus, as the viewer moves through the volumetric scene, the fog contribution changes smoothly and without layer artefacts that may result from a low-resolution layered 3D texture coding such as Embodiment 1.

The basic fog rendering algorithm uses the distance between the rendering camera and the closest surface intersecting the rendered pixel, i.e., scene depth, to compute the overall contribution of the fog on the final color. An additional monochrome texture patch may also be sent to indicate a per-pixel starting depth for the fog, and the distance between this starting depth and the closest surface used instead of the full scene depth.

As these per-pixel fog parameters are also stored in a video atlas and thus dynamic, they can be used to render dynamic fog with more realistic features than is possible using the static global fog model traditionally used in computer graphics.

The per-pixel attributes, as well as additional metadata, may also be optionally signaled on a per-patch basis to control the fog model being applied. For example:

| | Descriptor |
|---|---|
| fog_model( ) { | |
| fog_mode_ | u(2) |
| fog_start_depth | float(16) |
| fog_end_depth | float(16) |
| fog_density | float(16) |
| fog_color_red | u(8) |
| fog_color_green | u(8) |
| fog_color_blue | u(8) |
| } | |

fog mode indicates type of fog, for example FOG_EXPONENTIAL or FOG_LINEAR, which may indicate a physically based exponential fog function or a cheaper linear fog function, for example.

fog_start_depth indicates a fog starting depth for the patch that may be used in the absence of a per-pixel start depth attribute, and is used as the starting value of per-pixel fog start depths.

fog_end_depth indicates a fog ending depth for the patch that may be used by the FOG_LINEAR function in the absence of per-pixel fog start depths, and is used as the maximum value of per-pixel fog starting depths.

fog_density indicates a global fog density that is used in the absence of, or modulated by, per-pixel fog densities.

fog_color_red, fog_color_green, and fog_color_blue indicate a base color for the fog that may be used in the absence of per-pixel fog color attributes.

### Embodiment 2b: Multi-Layered Fog View

In an additional embodiment, the model of embodiment 2 may be extended to multiple layers. In contrast to a single layer, the renderer may then consider each layer where the starting depth is closer than the rendered geometry depth, and accumulate the layers on top of each other for the overall fog contribution.

### Embodiment 3: Separate Fog View Patches

In another embodiment, fog may be signaled as a separate set of patches without corresponding geometry and texture patches. For example, view-dependent light scattering or light shafts resulting from the sun or a spotlight are best encoded by specifying a view from the location of the light source and encoding the fog patches with respect to that view.

Similarly to signaling fog or volumetric textures, a new component type may be assigned for this type of content. By assigning a new component type for this new type of content a camera may be generated to reflect the origin of the light shaft or view-dependent scattering effect. A patch may be used to capture the volumetric effect from the camera position. The new component type should not conflict with the values described in table 7.1 in 23090-5.

Also, separate fog patches can have a resolution from the main geometry and textures in the scene. Thus, fog attributes may be stored in a separate 2D patch in the texture atlas, or even in a separate video stream. These fog patches may be scaled to a lower resolution than the main texture, as fog typically varies more smoothly than surface texture. This type of signaling is covered in FI Application No. 20205226 filed Mar. 4, 2020 and FI Application No. 20205280 filed Mar. 19, 2020.

### Embodiment 4: Basic Fog Volumes

In this embodiment, metadata is added for simple fog volumes. The metadata may include Shape: BOX or SPHERE, Dimensions: (for sphere) radius and center point, (for box) min/max XYZ extents, Fog density, and/or Fog color. The metadata may be signaled either as timed metadata or sequence level parameters. Alternatively, SEI messages or ISOBMFF level signaling may be used.

When rendering, the renderer may check for any contributions from fog volumes intersecting the viewing ray and add the fog contributions based on the fog function and the distance traveled through each volume.

### Embodiment 5: Simple Global or Per-View Fog

In this embodiment, basic global fog parameters of common graphics APIs are added to sequence metadata, including Fog type: EXPONENTIAL or LINEAR, Fog density, and/or Fog RGB color. The metadata is signaled either as timed metadata or sequence level parameters. Alternatively, SEI messages or ISOBMFF level signaling may be used.

Additionally, these parameters may be represented separately for each view, and interpolated between views. The parameters may be time-varying metadata, allowing changes over time.

As an advantage, this embodiment allows a traditional 3D graphics rendering pipeline to be used if embedding content into a volumetric video. Having rendered the volumetric video and its corresponding depth buffer, the (interpolated) set of fog parameters is readily available to the renderer for applying to any additional 3D graphics elements rendered on top, without any costly methods to resolve the fog contributions.

### Embodiment 6: Baked Vs Non-Baked Fog

This embodiment is orthogonal to the others and can be combined with any one of them. Here, a sequence-level metadata flag is added to indicate whether the volumetric fog component is pre-baked into the volumetric video textures or not. One bit of metadata is sufficient for this.

In the case of pre-baked fog, the colors stored in the texture atlas already include the contribution of the fog component as seen from the corresponding viewpoint. The view synthesizer for the volumetric video component, thus, need not take the fog component into account, simplifying the rendering. The fog is applied to 3D graphics elements added to or composited on top of the volumetric video scene. However, the fog component may introduce considerable redundancy into the volumetric video textures, adversely affecting compression and/or quality of the volumetric video.

With non-baked fog, the colors in the texture atlas have the fog component removed. This requires that the view synthesizer apply the fog per pixel when rendering the volumetric video component, making the rendering more complex depending on the fog specification in the current sequence. However, since the fog contribution is not duplicated in the different coded views, this may enable quality and/or compression improvements depending on the content.

An example patch structure is provided below:

| | Descriptor |
|---|---|
| patch( ) { | |
| /* already defined patch data */ | |
| contains_baked_fog | u(1) |
| } | |

contains_baked_fog signals if the patch contains baked fog to avoid duplicating global fog contribution if such effect has been defined.

The examples described herein further relate to low resolution, high resolution residual coding, and volumetric video coding, where dynamic 3D objects or scenes are coded into video streams for delivery and playback. The MPEG standards PCC (Point Cloud Compression) and MIV (Metadata for Immersive Video) are two examples of such volumetric video compression.

In both PCC and MIV, a similar methodology is adopted: the 3D scene is segmented into a number of regions according to heuristics based on, for example, spatial proximity and/or similarity of the data in the region. The segmented regions are projected into 2D patches, where each patch contains at least surface texture and depth channels, the depth channel giving the displacement of the surface pixels from the 2D projection plane associated with that patch. The patches are further packed into an atlas that can be streamed as a regular 2D video. As mentioned previously, this is also the methodology for V3C.

A characteristic of MIV in particular that relates to the examples described herein is that each patch is a (perspective) projection toward a virtual camera location, with a set of such virtual camera locations residing in or near the intended viewing space (and as described previously, the viewing region) of the scene in question. The viewing space (and as described previously, the viewing region) is a sub-volume of space inside which the viewer may move while viewing the scene. Thus, the patches in MIV are effectively small views of the scene. These views are then interpolated (e.g., a between interpolation) in order to synthesize the final view seen by the viewer. This view synthesis necessitates considerable overlap and similarity between adjacent views to mitigate discontinuities during view interpolation.

Large and/or complex scenes may not fit completely in device memory. This requires view-dependent delivery where the client is sent some subset of the full scene data relevant to the current view position, orientation, or other parameters. In a full 6DOF scene, one example of such a scheme is splitting the scene into adjacent sub-viewing spaces. These sub-viewing spaces form nodes in a grid or a mesh network so that the client can always fetch the nodes closest to the current viewing location for visualization.

As used herein, a scene node is defined to mean a local subset of a volumetric video scene that defines a local viewing space and contains the views necessary for rendering at some target angular resolution from inside that viewing space. A complete scene consists of a set of scene nodes arranged in some spatial data structure that facilitates finding the scene nodes necessary for rendering from any 3D viewpoint inside the viewing space of the complete scene.

Also, view optimization is defined to mean the overall process of splitting the scene into scene nodes, and segmenting the content visible to each scene node into views and patches. View optimization targets a certain output resolution for the content. The target resolution may be spatial (e.g., 1 point/mm) or angular (e.g., 0.1 degree point size when projected to the viewing space), and view optimization may entail downsampling of the scene content to remove excess resolution from the input data.

The problem in view-based coding is that encoding a complex scene requires potentially a very large number of views, while the content of those views is largely redundant. This requires both storage space in the cloud and network bandwidth to deliver the views to the client.

A related problem is scalable and view-dependent delivery: as the user can rapidly turn and move in the scene, it is desirable to have some lower-quality representation of the scene available in the neighborhood of the current viewing parameters so that the client can avoid presenting areas with completely missing data. This lower-quality representation in the worst case requires additional data that becomes redundant after the full-resolution data becomes available. OMAF enables a 360 degree video to be split into tiles for partial delivery.

Computer games and 3D map systems often employ a “level of detail” mechanism where a less detailed model is first presented until the full resolution is streamed from a data store or the overall complexity of the scene falls low enough for the rendering to be achieved at a sufficient frame rate. Scalable video coding codes 2D video as base and enhancement layers.

The examples described herein include separating a volumetric video scene into detail layers that are not completely redundant, but complement each other while serving to remove some of the redundancy between views and facilitating efficient view-dependent streaming with smooth transitions.

In the simple embodiment, the scene is divided into a low-resolution base layer and a full-resolution detail layer. The base layer is downsampled to substantially lower resolution than the target rendering resolution. This enables the low-resolution layer to be encoded with larger and more sparsely spaced scene nodes without introducing too much distortion when moving from node to node.

The detail layer encodes views at the full output resolution, but instead of coding absolute values, it encodes the difference between the full-resolution view and a view of the base layer rendered using the same viewing parameters.

Further embodiments are described in the stream metadata, and the encoder and renderer implementations.

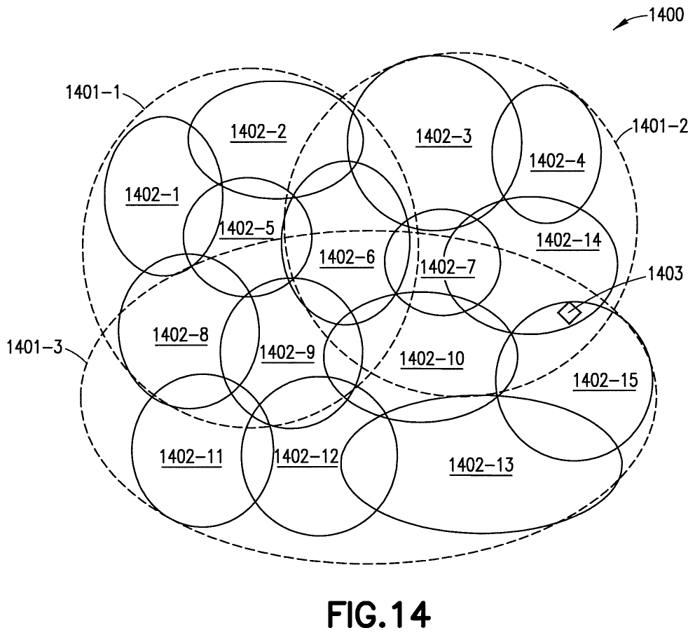

FIG. 14 shows an example of the proposed layout 1400 of a volumetric video scene. The low-resolution base layer is split into overlapping viewing spaces 1401 indicated by dashed outlines 1401-1, 1401-2, and 1401-3, while the high-resolution detail layer consists of many smaller viewing volumes shown by the solid circles (1402-1, 1402-2, 1402-3, 1402-4, 1402-5, 1402-6, 1402-7, 1402-8, 1402-9, 1402-10, 1402-11, 1402-12, 1402-13, 1402-14, 1402-15). Each viewing volume 1402-1 through 1402-15, in both base 1401 and detail layer 1402, may be assumed to contain a similar amount of data. The examples herein enable the viewer, illustrated by the diamond 1403, to render a visualization of the scene by considering the base 1401 and detail 1402 nodes overlapping the viewing position at 1403.

Thus, FIG. 14 shows an example base 1401 and detail 1402 layers covering a volumetric video scene. In FIG. 14, nodes 1402-14 and 1402-15 are sufficient for rendering the scene from the viewing position 1403 indicated by the diamond. Note that in real scenes, the shape and size of the scene nodes may vary greatly depending on scene content.

The first stage in encoding (e.g., a basic coding embodiment) is to create the base layer. This is accomplished by applying a view optimization process to the entire scene, with a target resolution of, for example, ¼th of the final output resolution. This produces a set of sparse scene nodes that can be used to synthesize low-resolution views of the scene.

The second stage is full-resolution view optimization. This can be accomplished as an independent process, resulting in a dense set of scene nodes that can be used for full-resolution view synthesis.

The third and final stage is differential coding of the high-resolution detail views. This can be accomplished by synthesizing the base layer view B corresponding to each full-resolution view A, and computing a differential view A′=A−B. The views A′ and B are then packed and compressed instead of the absolute views A. This serves two purposes.

First, since the common low-resolution component B is encoded once, the residual data in A′ can be compressed more efficiently. Second, the base layer B is shared by adjacent high-resolution views A′, resulting in more stable view synthesis.

Additional encoder embodiments may be implemented. In addition to the basic algorithm outlined above, several improvements can be made.

Instead of direct subtraction, alternative difference operators may be used. The main constraint is that the detail view representation must still allow interpolation between the detail views. For example, a frequency-domain coding of the detail layer can also be used.

Instead of working with the scene data directly, the detail layer view optimization may work on the difference between the base layer and the input scene content. This enables the optimizer to make use of the base layer and encode residual data where it is most beneficial from a rate-distortion point of view.

Additional low-pass filtering or other preprocessing can be applied to the base layer to ensure the smoothness of the base layer data. It is worth noting that this has no effect on the reconstruction algorithm, as the difference operator may be applied after any such preprocessing.

Instead of having a single detail layer, multiple detail layers at different resolutions can be used. This enables additional scalability and allows more efficient spatial frequency-based coding, for example.

Rendering of the content can be implemented in two rendering passes. First, a view W of the base layer is synthesized. Then a view V′ of the residual information in the detail layer is synthesized. The final high-resolution view V is reconstructed as V=W+V′.

Additional rendering embodiments are also possible. In a practical implementation, the two rendering passes can be combined into a single rendering pass that evaluates the base layer and detail layer(s) together. Similarly to encoding, a reconstruction operator different from basic addition can be used. This operator may match the difference operator used in the encoding phase. Similarly to encoding, the number of detail layers may be more than one.

Metadata in volumetric video standards may be implemented. The required metadata can be signaled at multiple levels. The basic metadata for each scene layer includes: layer number (e.g. zero for base layer, increasing for successive detail layers), a layer combination operator, scene node locations, and scene node viewing spaces.

In an embodiment, this metadata can be signaled entirely at the systems level, and the scene nodes can be, for example, in MIV or V-PCC format. The application may then implement the corresponding streaming logic to download the necessary scene nodes based on its current viewing parameters, and the rendering algorithm to combine them during rendering. As an example, each scene layer may be stored in a separate track and related metadata may be stored inside SampleEntries of said tracks, provided that the subdivision of the scene into sub-viewing volumes and scene layers can be considered static. SampleGroupDescription entries may be considered a more suitable option for metadata storage, if subdivision into sub-viewing volumes is dynamic, i.e. if subdivision is based on timing information.

In an embodiment, the metadata may be signaled in DASH manifest. Each scene layer should be signaled as a different Adaptation Set and information regarding layer numbering and other data as described previously should be made available as attributes of said Adaptation Sets. The proposed signaling allows DASH clients to distinguish between scene layers and choose best fitting components of volumetric video for streaming.

In another embodiment, the layer metadata can be signaled in the atlas or patch metadata of an MIV or V-PCC bitstream. The layer number and operator can be signaled per atlas or per patch. This enables differential coding inside the volumetric video bitstream, and can be combined with, for example, the tile-based access mechanism already defined in those standards. FI Application No. 20205226 filed Mar. 4, 2020 and FI Application No. 20205280 filed Mar. 19, 2020 describe signaling related functionality if per patch metadata is considered.

Scalable streaming embodiments may also be implemented. Having a hierarchy of a base layer and N detail layers enables greater scalability of the client application than having a single resolution. The layers are encoded in priority order, so the client can adjust the stream by two means, namely 1) adjusting the spatial extent of the area downloaded for each layer, and 2) adjusting the level of detail by downloading more or fewer detail layers.

As an example, the application may choose to cache more scene nodes from the base layer to account for rapid viewer motion, while downloading the higher detail layers when the viewer motion stabilizes.

In an embodiment, averaged orthogonal projections may cover the scene in the base layer, with the detail layer(s) providing view-dependent details specific to different viewing directions and/or locations.

There are several advantages and technical effects of the examples described herein. For example, the described examples provide a clear path for scalability of a volumetric video scene representation. By employing multiple levels of detail, a viewing application can achieve progressive streaming of the content, adapting the presentation to network bandwidth and availability of rendering performance and other client resources.

Separating the base and detail layers into scene nodes with overlapping viewing volumes enables the client to smoothly transition between different presentation resolutions and viewing positions without visual discontinuities. As the detail layers code the difference from the base layer, the coded representation can greatly reduce the spatial redundancy between different coded viewpoints, leading to higher coding efficiency.

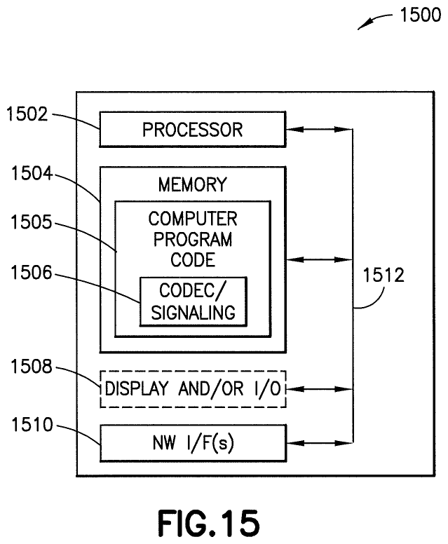

FIG. 15 is an example apparatus 1500, which may be implemented in hardware, configured to implement coding, decoding, and/or signaling based on the example embodiments described herein. The apparatus 1500 comprises a processor 1502, at least one non-transitory or transitory memory 1504 including computer program code 1505, wherein the at least one memory 1504 and the computer program code 1505 are configured to, with the at least one processor 1502, cause the apparatus 1500 to implement a process, component, module, or function (collectively 1506) to implement encoding, decoding, and/or signaling based on the example embodiments described herein. The apparatus 1500 optionally includes a display and/or I/O interface 1508 that may be used to display aspects or a status of any of the methods described herein (e.g., as the method is being performed or at a subsequent time). The apparatus 1500 includes one or more network (NW) interfaces (I/F(s)) 1510. The NW I/F(s) 1510 may be wired and/or wireless and communicate over the Internet/other network(s) via any communication technique. The NW I/F(s) 1510 may comprise one or more transmitters and one or more receivers. The N/W I/F(s) 1510 may comprise standard well-known components such as an amplifier, filter, frequency-converter, (de)modulator, and encoder/decoder circuitry(ies) and one or more antennas. The apparatus 1500 may be implemented as a decoder or encoder. In some examples, the processor 1502 is configured to implement codec/signaling 1506 without use of memory 1504.

The memory 1504 may be implemented using any suitable data storage technology, such as semiconductor based memory devices, flash memory, magnetic memory devices and systems, optical memory devices and systems, fixed memory and removable memory. The memory 1504 may comprise a database for storing data. Interface 1512 enables data communication between the various items of apparatus 1500, as shown in FIG. 15. Interface 1512 may be one or more buses, or interface 1512 may be one or more software interfaces configured to pass data within computer program code 1505 or between the items of apparatus 1500. For example, the interface 1512 may be an object-oriented interface in software, or the interface 1512 may be one or more buses such as address, data, or control buses, and may include any interconnection mechanism, such as a series of lines on a motherboard or integrated circuit, fiber optics or other optical communication equipment, and the like. The apparatus 1500 need not comprise each of the features mentioned, or may comprise other features as well. The apparatus 1500 may be an embodiment of apparatuses and/or signaling shown in FIG. 1, FIG. 2, FIG. 3A, FIG. 3B, FIG. 4, FIG. 5, FIG. 6, FIG. 7, FIG. 8, FIG. 9, FIG. 10, FIG. 11, FIG. 12, FIG. 13, or FIG. 14, including any combination of those. Apparatus 1500 may implement method 1600, method 1700, and/or method 1800.

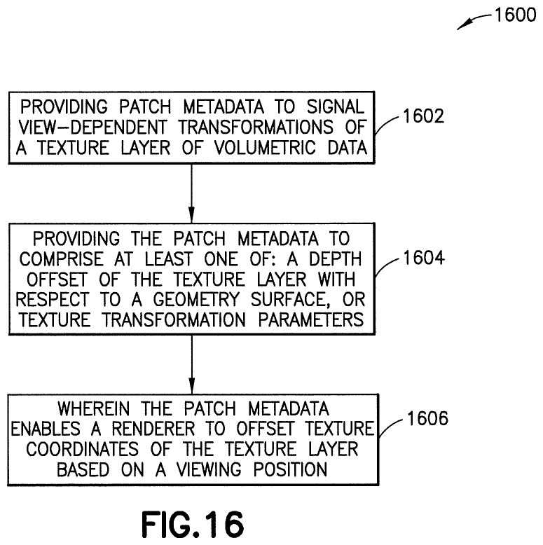

FIG. 16 is an example method 1600 for implementing coding, decoding, and/or signaling based on the example embodiments described herein. At 1602, the method includes providing patch metadata to signal view-dependent transformations of a texture layer of volumetric data. At 1604, the method includes providing the patch metadata to comprise at least one of: a depth offset of the texture layer with respect to a geometry surface, or texture transformation parameters. At 1606, the method includes wherein the patch metadata enables a renderer to offset texture coordinates of the texture layer based on a viewing position.

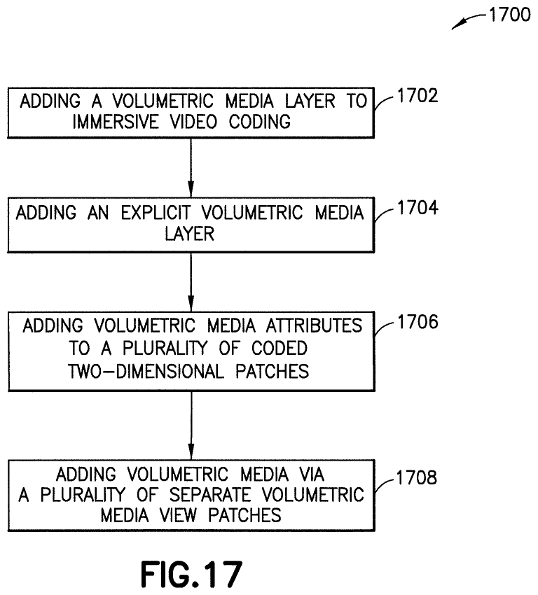

FIG. 17 is an example method 1700 for implementing coding, decoding, and/or signaling based on the example embodiments described herein. At 1702, the method includes adding a volumetric media layer to immersive video coding. At 1704, the method includes adding an explicit volumetric media layer. At 1706, the method includes adding volumetric media attributes to a plurality of coded 2D patches. At 1708, the method includes adding volumetric media via a plurality of separate volumetric media view patches.

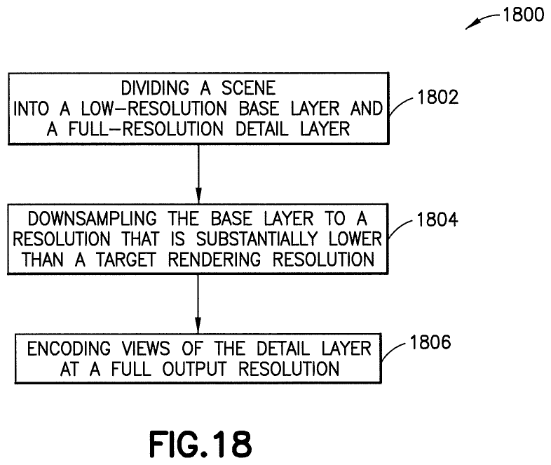

FIG. 18 is an example method 1800 for implementing coding, decoding, and/or signaling based on the example embodiments described herein. At 1802, the method includes dividing a scene into a low-resolution base layer and a full-resolution detail layer. At 1804, the method includes downsampling the base layer to a resolution that is substantially lower than a target rendering resolution. At 1806, the method includes encoding views of the detail layer at a full output resolution.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

Based on the examples referred to herein, an example apparatus may be provided that includes at least one processor; and at least one non-transitory memory including computer program code; wherein the at least one memory and the computer program code are configured to, with the at least one processor, cause the apparatus at least to: provide patch metadata to signal view-dependent transformations of a texture layer of volumetric data; provide the patch metadata to comprise at least one of: a depth offset of the texture layer with respect to a geometry surface, or texture transformation parameters; and wherein the patch metadata enables a renderer to offset texture coordinates of the texture layer based on a viewing position.

The apparatus may further include wherein the at least one memory and the computer program code are further configured to, with the at least one processor, cause the apparatus at least to: provide specular patch metadata by encoding per-pixel specular lobe metadata as a texture patch, each pixel corresponding to a three-dimensional point in an associated geometry patch; and wherein the specular patch metadata enables the renderer to vary a specular highlight contribution on a per-pixel basis based on viewer motion.

The apparatus may further include wherein the at least one memory and the computer program code are further configured to, with the at least one processor, cause the apparatus at least to: provide multiple offset textures per patch, each offset texture having different parameters.

The apparatus may further include wherein the renderer uses a geometric relationship resulting from the depth offset, an original position, and a position of a synthesized viewpoint to compute a coordinate texture (UV) coordinate offset to apply to projected texture coordinates of an offset texture.

The apparatus may further include wherein the depth offset is signaled within a patch data unit structure, or as a supplemental enhancement information message.

The apparatus may further include wherein the at least one memory and the computer program code are further configured to, with the at least one processor, cause the apparatus at least to: signal a value indicating a range of depth values by an offset geometry patch representing the shape of a reflected or refracted object.

The apparatus may further include wherein the at least one memory and the computer program code are further configured to, with the at least one processor, cause the apparatus at least to: offset coordinate texture (UV) coordinates based on the depth offset; and sample iteratively the offset geometry patch until a difference between a per-pixel intersection and the offset geometry patch is within a threshold.

The apparatus may further include wherein the at least one memory and the computer program code are further configured to, with the at least one processor, cause the apparatus at least to: signal a coordinate texture (UV) coordinate transformation to simulate reflection and/or refraction effects.

The apparatus may further include wherein the at least one memory and the computer program code are further configured to, with the at least one processor, cause the apparatus at least to: signal at least one of texture translation parameters or texture scale parameters for generation of view-dependent texture animation.

The apparatus may further include wherein the at least one memory and the computer program code are further configured to, with the at least one processor, cause the apparatus at least to: compute shifted texture coordinates as t′=S·t+T, where t represents base layer texture coordinates, S represents the texture scale parameters and T represents the texture translation parameters.

The apparatus may further include wherein the at least one memory and the computer program code are further configured to, with the at least one processor, cause the apparatus at least to: determine a specular color contribution S as S=C intensity(|s|) max(0, dot(s/|s|, v)^{power(|s|)}; wherein: C is a peak specular color for the texture patch; s is a specular vector value stored in a specular patch; v is a normalized viewing direction vector; the function intensity( ) is a mapping function from a specular vector magnitude to peak specular intensity; and the function power( ) is specular power.

The apparatus may further include wherein the at least one memory and the computer program code are further configured to, with the at least one processor, cause the apparatus at least to: signal at least one of: a specular color to indicate a static value for a specular color component; a specular intensity function to indicate a type of function used for intensity when sampling a final color of a specular reflection; a specular power function to indicate a type of function used for power when sampling the final color of the specular reflection; or specular vector information within a specular vector video data component.

The apparatus may further include wherein the at least one memory and the computer program code are further configured to, with the at least one processor, cause the apparatus at least to: iterate over a range of depth offset values; project one or more source cameras to depths specified by the range of the depth offset values; and determine candidate depths that produce a match between projected source camera textures.

The apparatus may further include wherein the at least one memory and the computer program code are further configured to, with the at least one processor, cause the apparatus at least to: determine an intersection of a viewing ray and a main surface; compute coordinate texture (UV) coordinates of a main texture using projective texturing; for each offset layer, fetch color and occupancy samples from a final coordinate texture (UV) coordinate after shifting; blend an offset layer with a main layer according to a final occupancy value; and for each specular highlight layer, add a contribution to a texture color accumulated from previous texture and specular layers.

Based on the examples referred to herein, an example apparatus may be provided that includes at least one processor; and at least one non-transitory memory including computer program code; wherein the at least one memory and the computer program code are configured to, with the at least one processor, cause the apparatus at least to: add a volumetric media layer to immersive video coding; adding an explicit volumetric media layer; adding volumetric media attributes to a plurality of coded two-dimensional (2D) patches; and adding volumetric media via a plurality of separate volumetric media view patches.

The apparatus may further include wherein adding the explicit volumetric media layer comprises providing a volumetric media data type as a three-dimensional (3D) grid of samples that is coded as layered two-dimensional (2D) image tiles in a video atlas at a lower resolution than a main media content.

The apparatus may further include wherein adding volumetric media attributes to the plurality of coded two-dimensional (2D) patches comprises extending already coded two-dimensional (2D) view patches with fog attributes that enable application programming interface fog attributes per pixel to allow fog color and density to vary across each two-dimensional (2D) patch.

The apparatus may further include wherein adding volumetric media via the plurality of separate volumetric media view patches comprises separating participating media attributes into their own views, and storing parameters within each volumetric media view patch, wherein the participating media views have a different spatial or temporal layout from a main texture and the volumetric media view patches.

The apparatus may further include wherein volumetric media view patches may be baked in the scene or interactive.

Based on the examples referred to herein, an example apparatus may be provided that includes at least one processor; and at least one non-transitory memory including computer program code; wherein the at least one memory and the computer program code are configured to, with the at least one processor, cause the apparatus at least to: divide a scene into a low-resolution base layer and a full-resolution detail layer; downsample the base layer to a resolution that is substantially lower than a target rendering resolution; and encode views of the detail layer at a full output resolution.

The apparatus may further include wherein the encoding comprises encoding a difference between a full-resolution view and a view of the base layer rendered using parameters used by the detail layer.

The apparatus may further include wherein the scene contains information regarding the number of layers, used compositing operation, scene node locations and viewing spaces.

The apparatus may further include wherein the rendering of content consisting of the base layer and an enhancement layer is done, with first synthesizing a view from the base layer and secondly compositing a synthesized enhancement layer detail on top of the synthesized base layer view.

Based on the examples referred to herein, an example method may be provided that includes providing patch metadata to signal view-dependent transformations of a texture layer of volumetric data; providing the patch metadata to comprise at least one of: a depth offset of the texture layer with respect to a geometry surface, or texture transformation parameters; and wherein the patch metadata enables a renderer to offset texture coordinates of the texture layer based on a viewing position.

Based on the examples referred to herein, an example method may be provided that includes adding a volumetric media layer to immersive video coding; adding an explicit volumetric media layer; adding volumetric media attributes to a plurality of coded two-dimensional (2D) patches; and adding volumetric media via a plurality of separate volumetric media view patches.

Based on the examples referred to herein, an example method may be provided that includes dividing a scene into a low-resolution base layer and a full-resolution detail layer; downsampling the base layer to a resolution that is substantially lower than a target rendering resolution; and encoding views of the detail layer at a full output resolution.

Based on the examples referred to herein, an example non-transitory program storage device readable by a machine, tangibly embodying a program of instructions executable by the machine for performing operations may be provided, the operations comprising: providing patch metadata to signal view-dependent transformations of a texture layer of volumetric data; providing the patch metadata to comprise at least one of: a depth offset of the texture layer with respect to a geometry surface, or texture transformation parameters; and wherein the patch metadata enables a renderer to offset texture coordinates of the texture layer based on a viewing position.

Based on the examples referred to herein, an example non-transitory program storage device readable by a machine, tangibly embodying a program of instructions executable by the machine for performing operations may be provided, the operations comprising: adding a volumetric media layer to immersive video coding; adding an explicit volumetric media layer; adding volumetric media attributes to a plurality of coded two-dimensional (2D) patches; and adding volumetric media via a plurality of separate volumetric media view patches.

Based on the examples referred to herein, an example non-transitory program storage device readable by a machine, tangibly embodying a program of instructions executable by the machine for performing operations may be provided, the operations comprising: dividing a scene into a low-resolution base layer and a full-resolution detail layer; downsampling the base layer to a resolution that is substantially lower than a target rendering resolution; and encoding views of the detail layer at a full output resolution.

Based on the examples referred to herein, an example apparatus may be provided that includes means for providing patch metadata to signal view-dependent transformations of a texture layer of volumetric data; means for providing the patch metadata to comprise at least one of: a depth offset of the texture layer with respect to a geometry surface, or texture transformation parameters; and wherein the patch metadata enables a renderer to offset texture coordinates of the texture layer based on a viewing position.

The apparatus may further include means for providing specular patch metadata by encoding per-pixel specular lobe metadata as a texture patch, each pixel corresponding to a three-dimensional point in an associated geometry patch; and wherein the specular patch metadata enables the renderer to vary a specular highlight contribution on a per-pixel basis based on viewer motion.

The apparatus may further include means for providing multiple offset textures per patch, each offset texture having different parameters.

The apparatus may further include wherein the renderer uses a geometric relationship resulting from the depth offset, an original position, and a position of a synthesized viewpoint to compute a coordinate texture (UV) coordinate offset to apply to projected texture coordinates of an offset texture.

The apparatus may further include wherein the depth offset is signaled within a patch data unit structure, or as a supplemental enhancement information message.

The apparatus may further include means for signaling a value indicating a range of depth values by an offset geometry patch representing the shape of a reflected or refracted object.

The apparatus may further include means for offsetting coordinate texture (UV) coordinates based on the depth offset; and means for sampling iteratively the offset geometry patch until a difference between a per-pixel intersection and the offset geometry patch is within a threshold.

The apparatus may further include means for signaling a coordinate texture (UV) coordinate transformation to simulate reflection and/or refraction effects.

The apparatus may further include means for signaling at least one of texture translation parameters or texture scale parameters for generation of view-dependent texture animation.

The apparatus may further include means for computing shifted texture coordinates as t′=S·t+T, where t represents base layer texture coordinates, S represents the texture scale parameters and T represents the texture translation parameters.

The apparatus may further include means for determining a specular color contribution S as S=C intensity(|s|) max(0, dot(s/|s|, v))^{power(|s|)}; wherein: C is a peak specular color for the texture patch; s is a specular vector value stored in a specular patch; v is a normalized viewing direction vector; the function intensity( ) is a mapping function from a specular vector magnitude to peak specular intensity; and the function power( ) is specular power.

The apparatus may further include means for signaling at least one of: a specular color to indicate a static value for a specular color component; a specular intensity function to indicate a type of function used for intensity when sampling a final color of a specular reflection; a specular power function to indicate a type of function used for power when sampling the final color of the specular reflection; or specular vector information within a specular vector video data component.

The apparatus may further include means for iterating over a range of depth offset values; means for projecting one or more source cameras to depths specified by the range of the depth offset values; and means for determining candidate depths that produce a match between projected source camera textures.

The apparatus may further include means for determining an intersection of a viewing ray and a main surface; means for computing coordinate texture (UV) coordinates of a main texture using projective texturing; means for, for each offset layer, fetching color and occupancy samples from a final coordinate texture (UV) coordinate after shifting; means for blending an offset layer with a main layer according to a final occupancy value; and means for, for each specular highlight layer, adding a contribution to a texture color accumulated from previous texture and specular layers.

Based on the examples referred to herein, an example apparatus may be provided that includes means for adding a volumetric media layer to immersive video coding; means for adding an explicit volumetric media layer; means for adding volumetric media attributes to a plurality of coded two-dimensional (2D) patches; and means for adding volumetric media via a plurality of separate volumetric media view patches.

The apparatus may further include wherein adding the explicit volumetric media layer comprises providing a volumetric media data type as a three-dimensional (3D) grid of samples that is coded as layered two-dimensional (2D) image tiles in a video atlas at a lower resolution than a main media content.

The apparatus may further include wherein adding volumetric media attributes to the plurality of coded two-dimensional (2D) patches comprises extending already coded two-dimensional (2D) view patches with fog attributes that enable application programming interface fog attributes per pixel to allow fog color and density to vary across each two-dimensional (2D) patch.

The apparatus may further include wherein adding volumetric media via the plurality of separate volumetric media view patches comprises separating participating media attributes into their own views, and storing parameters within each volumetric media view patch, wherein the participating media views have a different spatial or temporal layout from a main texture and the volumetric media view patches.

The apparatus may further include wherein volumetric media view patches may be baked in the scene or interactive.

Based on the examples referred to herein, an example apparatus may be provided that includes means for dividing a scene into a low-resolution base layer and a full-resolution detail layer; means for downsampling the base layer to a resolution that is substantially lower than a target rendering resolution; and means for encoding views of the detail layer at a full output resolution.

The apparatus may further include wherein the encoding comprises encoding a difference between a full-resolution view and a view of the base layer rendered using parameters used by the detail layer.

The apparatus may further include wherein the scene contains information regarding the number of layers, used compositing operation, scene node locations and viewing spaces.

The apparatus may further include wherein the rendering of content consisting of the base layer and an enhancement layer is done, with first synthesizing a view from the base layer and secondly compositing a synthesized enhancement layer detail on top of the synthesized base layer view.

Based on the examples referred to herein, an example apparatus may be provided that includes circuitry configured to provide patch metadata to signal view-dependent transformations of a texture layer of volumetric data; circuitry configured to provide the patch metadata to comprise at least one of: a depth offset of the texture layer with respect to a geometry surface, or texture transformation parameters; and wherein the patch metadata enables a renderer to offset texture coordinates of the texture layer based on a viewing position.

Based on the examples referred to herein, an example apparatus may be provided that includes circuitry configured to add a volumetric media layer to immersive video coding; circuitry configured to add an explicit volumetric media layer; circuitry configured to add volumetric media attributes to a plurality of coded two-dimensional (2D) patches; and circuitry configured to add volumetric media via a plurality of separate volumetric media view patches.

Based on the examples referred to herein, an example apparatus may be provided that includes circuitry configured to divide a scene into a low-resolution base layer and a full-resolution detail layer; circuitry configured to downsample the base layer to a resolution that is substantially lower than a target rendering resolution; and circuitry configured to encode views of the detail layer at a full output resolution.

It should be understood that the foregoing description is merely illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
2D two-dimensional
3D or 3d three-dimensional
6DOF six degrees of freedom
ACL atlas coding layer
AFPS atlas frame parameter set
API application programming interface
AR augmented reality
ASIC application-specific integrated circuit
ASPS atlas sequence parameter set
b(8) byte having any pattern bit string (8 bits)
CGI Computer-Generated Imagery
D3D Direct3D
DASH Dynamic Adaptive Streaming over HTTP
e.g. for example
Exp exponential
f(n) fixed-pattern bit string using n bits
FPGA field programmable gate array
HRD hypothetical reference decoder
HTTP Hypertext Transfer Protocol
id identifier
i.e. that is
IEC International Electrotechnical Commission
I/F interface
I/O input/output
ISO International Organization for Standardization
ISOBMFF ISO/IEC base media file format
MIV MPEG Immersive Video, or Metadata for Immersive Video
MPEG moving picture experts group
MR mixed reality
NAL network abstraction layer
No. number
NW network
OpenGL Open Graphics Library
OMAF Omnidirectional Media Format
PCC Point Cloud Compression
PERT Physically Based Rendering file or system
RBG red, green, blue color model
RGBA red green blue alpha, or the three-channel RGB color model supplemented with a fourth alpha channel such as opacity or other attribute data
RBSP raw byte sequence payload
SEI supplemental enhancement information
se(v) signed integer 0-th order Exp-Golomb-coded syntax element
SODB string of data bits
u(n) unsigned integer using n bits
U an axis of a 2D texture
UV coordinate texture, where “U” and “V” denote the axes of the 2D texture
u(v) unsigned integer where the number of bits varies in a manner dependent on the value of other syntax elements
ue(v) unsigned integer 0-th order Exp-Golomb-coded syntax element
V an axis of a 2D texture
V3C visual volumetric video-based coding
VPCC or V-PCC Video based Point Cloud coding standard or Video-based Point Cloud Compression
VPS V-PCC parameter set
VR virtual reality
VRD viewing ray deviation

1. An apparatus comprising:
at least one processor; and
at least one non-transitory memory including computer program code;
wherein the at least one memory and the computer program code are configured to, with the at least one processor, cause the apparatus at least to:
provide patch metadata to signal view-dependent transformations of a texture layer of volumetric data;
provide the patch metadata to comprise at least one of:
a depth offset of the texture layer with respect to a geometry surface, or texture transformation parameters; and
wherein the patch metadata enables a renderer to offset texture coordinates of the texture layer based on a viewing position.

2. The apparatus of claim 1, wherein the at least one memory and the computer program code are further configured to, with the at least one processor, cause the apparatus at least to:
provide specular patch metadata by encoding per-pixel specular lobe metadata as a texture patch, each pixel corresponding to a three-dimensional point in an associated geometry patch; and
wherein the specular patch metadata enables the renderer to vary a specular highlight contribution on a per-pixel basis based on viewer motion.

3. The apparatus of claim 1, wherein the at least one memory and the computer program code are further configured to, with the at least one processor, cause the apparatus at least to:
provide multiple offset textures per patch, each offset texture having different parameters.

4. The apparatus of claim 1, wherein the renderer uses a geometric relationship resulting from the depth offset, an original position, and a position of a synthesized viewpoint to compute a coordinate texture coordinate offset to apply to projected texture coordinates of an offset texture.

5. The apparatus of claim 1, wherein the depth offset is signaled within a patch data unit structure, or as a supplemental enhancement information message.

6. The apparatus of claim 1, wherein the at least one memory and the computer program code are further configured to, with the at least one processor, cause the apparatus at least to:
signal a value indicating a range of depth values by an offset geometry patch representing the shape of a reflected or refracted object.

7. The apparatus of claim 6, wherein the at least one memory and the computer program code are further configured to, with the at least one processor, cause the apparatus at least to:
offset coordinate texture coordinates based on the depth offset; and
sample iteratively the offset geometry patch until a difference between a per-pixel intersection and the offset geometry patch is within a threshold.

8. The apparatus of claim 1, wherein the at least one memory and the computer program code are further configured to, with the at least one processor, cause the apparatus at least to:
signal a coordinate texture coordinate transformation to simulate reflection and/or refraction effects.

9. The apparatus of claim 1, wherein the at least one memory and the computer program code are further configured to, with the at least one processor, cause the apparatus at least to:
signal at least one of texture translation parameters or texture scale parameters for generation of view-dependent texture animation.

10. The apparatus of claim 9, wherein the at least one memory and the computer program code are further configured to, with the at least one processor, cause the apparatus at least to:
compute shifted texture coordinates as t′=S·t+T, where t represents base layer texture coordinates, S represents the texture scale parameters and T represents the texture translation parameters.

11. The apparatus of claim 2, wherein the at least one memory and the computer program code are further configured to, with the at least one processor, cause the apparatus at least to:
determine a specular color contribution S as S=C intensity(|s|) max(0, dot(s/|s|, v))^{power(|s|)};
wherein:
C is a peak specular color for the texture patch;
s is a specular vector value stored in a specular patch;
v is a normalized viewing direction vector;
the function intensity( ) is a mapping function from a specular vector magnitude to peak specular intensity; and
the function power( ) is specular power.

12. The apparatus of claim 1, wherein the at least one memory and the computer program code are further configured to, with the at least one processor, cause the apparatus at least to:
signal at least one of:
a specular color to indicate a static value for a specular color component;
a specular intensity function to indicate a type of function used for intensity when sampling a final color of a specular reflection;
a specular power function to indicate a type of function used for power when sampling the final color of the specular reflection; or
specular vector information within a specular vector video data component.

13. The apparatus of claim 1, wherein the at least one memory and the computer program code are further configured to, with the at least one processor, cause the apparatus at least to:
iterate over a range of depth offset values;
project one or more source cameras to depths specified by the range of the depth offset values; and
determine candidate depths that produce a match between projected source camera textures.

14. The apparatus of claim 1, wherein the at least one memory and the computer program code are further configured to, with the at least one processor, cause the apparatus at least to:
determine an intersection of a viewing ray and a main surface;
compute coordinate texture coordinates of a main texture using projective texturing;
for each offset layer, fetch color and occupancy samples from a final coordinate texture coordinate after shifting;
blend an offset layer with a main layer according to a final occupancy value; and
for each specular highlight layer, add a contribution to a texture color accumulated from previous texture and specular layers.

15. An apparatus comprising:
at least one processor; and
at least one non-transitory memory including computer program code;
wherein the at least one memory and the computer program code are configured to, with the at least one processor, cause the apparatus at least to:
add a volumetric media layer to immersive video coding;
add an explicit volumetric media layer;
add volumetric media attributes to a plurality of coded two-dimensional patches; and
add volumetric media via a plurality of separate volumetric media view patches.

16. The apparatus of claim 15, wherein adding the explicit volumetric media layer comprises providing a volumetric media data type as a three-dimensional grid of samples that is coded as layered two-dimensional image tiles in a video atlas at a lower resolution than a main media content.

17. The apparatus of claim 15, wherein adding volumetric media attributes to the plurality of coded two-dimensional patches comprises extending already coded two-dimensional view patches with fog attributes that enable application programming interface fog attributes per pixel to allow fog color and density to vary across each two-dimensional patch.

18. The apparatus of claim 15, wherein adding volumetric media via the plurality of separate volumetric media view patches comprises separating participating media attributes into their own views, and storing parameters within each volumetric media view patch, wherein the participating media views have a different spatial or temporal layout from a main texture and the volumetric media view patches.

19. The apparatus of claim 15, wherein volumetric media view patches may be baked in the scene or interactive.

20. An apparatus comprising:
at least one processor; and
at least one non-transitory memory including computer program code;
wherein the at least one memory and the computer program code are configured to, with the at least one processor, cause the apparatus at least to:
divide a scene into a low-resolution base layer and a full-resolution detail layer;
downsample the base layer to a resolution that is substantially lower than a target rendering resolution; and
encode views of the detail layer at a full output resolution.

21. The apparatus of claim 20, wherein the encoding comprises encoding a difference between a full-resolution view and a view of the base layer rendered using parameters used by the detail layer.

22. The apparatus of claim 20, wherein the scene contains information regarding the number of layers, used compositing operation, scene node locations and viewing spaces.

23. The apparatus of claim 20, wherein the rendering of content consisting of the base layer and an enhancement layer is done, with first synthesizing a view from the base layer and secondly compositing a synthesized enhancement layer detail on top of the synthesized base layer view.
